(19) United States
(12) Patent Application Publication
(10) Pub. No.: US 2014/0340913 A1
(43) Pub. Date: Nov. 20, 2014

(54) LED LIGHT BULB AND MANUFACTURING METHOD OF THE SAME

(71) Applicant: HONG JUAN CUI, North York (CA)

(72) Inventor: HONG JUAN CUI, North York (CA)

(21) Appl. No.: 13/897,358

(22) Filed: May 18, 2013

(51) Int. Cl. F21V 29/00; F21K 99/00

(52) U.S. Cl. CPC F21V 29/20; F21K 9/00; F21V 29/004
USPC 362/382

(57) ABSTRACT

The present invention discloses a LED light bulb, comprising: a LED printed circuit board, a sealed body and a base. The sealed body made of two thermoplastic parts form vapor transport channel inside the body that extends between two heat transfer locations spaced apart on an exterior surface of the body, a wick or a plurality of grooves in the vapor transport channel wall that extends between the two heat transfer locations, and a working fluid that partially fills the vapor transport channel. In a method of making this LED light bulb, the two thermoplastic parts are desirably formed together as a seamless monolithic structure, the LED printed circuit board is bent, mounted and fixed on the sealed body. With the apparatus and manufacturing method introduced by present invention, the LED light bulb would be ease for manufacturing, heat dissipation effective and cost effective. The sealed body transfers heat as a conventional heat pipe.

### BACKGROUND OF THE INVENTION

1. Field of the Invention

The present disclosure is related to a LED light bulb and manufacturing method of the same.

2. Description of Related Art

Light emitting diode (LED) has advantages of small size, long lifespan, low power consumption, luminescence and mercury free so that has become the main research project in illuminating field. However the LED chip creates significant heat during working. If heat could not dissipate properly, many problems will occur such as low light efficacy and short lifespan. Therefore, an efficient heat dissipating structure for a LED light bulb is necessary for removing the heat away from the illuminating module to avoid the aforementioned problems.

Various apparatus and techniques have been used and are presently being used for removing heat from LED chips in the LED light bulb design. One such heat dissipation technique involves the attachment of a high surface area metal heat sink to LED chips. Due to the manufacturing methods limitation and physical geometry of the heat sink, thus increase the cost, size and weight of the light bulb.

Another method is using thermal conductive plastic material heat sink instead of metal heat sink. Due to the thermal conductive plastic material has less perfect heat conductivity and higher cost than metal, its usage especially in high power light bulb is limited.

Therefore, it would be advantageous to develop a LED light bulb apparatus to effectively remove heat from LED chips, with higher heat dissipation ability, lower material cost and less manufacturing constraints.

### SUMMARY OF THE INVENTION

An object of the present invention is to provide a novel LED light bulb apparatus includes a body that on which LED printed circuit board can be mounted directly.

A further object of the present invention is to provide a novel LED light bulb apparatus with said body made of two thermoplastic parts, said body being sealed and having cavity suction apparatus inside said body that extends between two heat transfer locations spaced apart on an exterior surface of said body, a vapor transport channel inside said body that extends between said two heat transfer locations, and a working fluid that partially fills said vapor transport channel.

A further object of the present invention is to provide a novel LED light bulb apparatus with a LED printed circuit board, said LED printed circuit board is desirably designed to be bent, mounted on and fixed on said body.

Another object of the present invention is to provide a novel method of making this novel LED light bulb apparatus that includes providing a body of two thermoplastic parts, providing cavity suction apparatus and a vapor transport channel inside said body, said cavity suction apparatus and said vapor transport channel that extends between two heat transfer locations spaced apart on an exterior surface of said body, evacuating said body, providing a working fluid inside said body that partially fills said vapor transport channel, and sealing said body closed.

A further object of the present invention is to provide a novel method of making this novel LED light bulb apparatus that bend, mount and fix the LED printed circuit board on said body.

### BRIEF DESCRIPTION OF THE DRAWINGS

FIG. 1 is a pictorial cutaway view of an embodiment of the present invention.

FIG. 2 is a pictorial representation of an embodiment of the present invention.

FIG. 3 is a pictorial exploded view of an embodiment of the present invention.

FIG. 4 is a pictorial exploded cutaway view of an embodiment of the present invention.

FIG. 5 is a pictorial cutaway view of a sub-assembly of an embodiment of the present invention.

FIG. 6 is a pictorial representation of a outer part of an embodiment of the present invention.

FIG. 7 is a pictorial representation of a outer part of an embodiment of the present invention, with showing section planes position from perspective view.

FIG. 8 is a pictorial representation of a outer part of an embodiment of the present invention, with showing section planes position from top view.

FIG. 9 is a pictorial cutaway view of a outer part of an embodiment of the present invention taken along the section plane 40 in FIG. 7 and FIG. 8.

FIG. 10 is a pictorial cutaway view of a outer part of an embodiment of the present invention taken along the section plane 41 in FIG. 7 and FIG. 8.

FIG. 11 is a pictorial cutaway view of a outer part of an embodiment of the present invention taken along the section plane 42 in FIG. 7 and FIG. 8.

FIG. 12 is a pictorial representation of a inner part of an embodiment of the present invention.

FIG. 13 is a pictorial representation of a inner part of an embodiment of the present invention, with showing section planes position from perspective view.

FIG. 14 is a pictorial representation of a inner part of an embodiment of the present invention, with showing section planes position from top view.

FIG. 15 is a pictorial cutaway view of a inner part of an embodiment of the present invention taken along the section plane 46 in FIG. 13 and FIG. 14.

FIG. 16 is a pictorial cutaway view of a inner part of an embodiment of the present invention taken along the section plane 47 in FIG. 13 and FIG. 14.

FIG. 17 is a pictorial cutaway view of a inner part of an embodiment of the present invention taken along the section plane 48 in FIG. 13 and FIG. 14.

FIG. 18 is a pictorial cutaway view of a inner part of an embodiment of the present invention taken along the section plane 49 in FIG. 13 and FIG. 14.

FIG. 19 is a pictorial representation of a wick of an embodiment of the present invention.

FIG. 20 is a pictorial representation of a wick of an embodiment of the present invention, with showing section planes position from perspective view.

FIG. 21 is a pictorial representation of a wick of an embodiment of the present invention, with showing section planes position from top view.

FIG. 22 is a pictorial cutaway view of a wick of an embodiment of the present invention taken along the section plane 43 in FIG. 20 and FIG. 21.

FIG. 23 is a pictorial cutaway view of a wick of an embodiment of the present invention taken along the section plane 44 in FIG. 20 and FIG. 21.

FIG. 24 is a pictorial cutaway view of a wick of an embodiment of the present invention taken along the section plane 45 in FIG. 20 and FIG. 21.

FIG. 25 is a pictorial representation of a LED printed circuit board of an embodiment of the present invention.

FIG. 26 is a pictorial front view of a LED printed circuit board of an embodiment of the present invention.

FIG. 27 is a pictorial back view of a LED printed circuit board of an embodiment of the present invention.

FIG. 28 is a pictorial left side view of a LED printed circuit board of an embodiment of the present invention.

FIG. 29 is a pictorial top view of a LED printed circuit board of an embodiment of the present invention.

FIG. 30 is a pictorial representation of a bent LED printed circuit board of an embodiment of the present invention.

FIG. 31 is a pictorial representation of a bent LED printed circuit board of an embodiment of the present invention, with showing section planes position from perspective view.

FIG. 32 is a pictorial representation of a bent LED printed circuit board of an embodiment of the present invention, with showing section planes position from top view.

FIG. 33 is a pictorial cutaway view of a bent LED printed circuit board of an embodiment of the present invention taken along the section plane 50 in FIG. 31 and FIG. 32.

FIG. 34 is a pictorial cutaway view of a bent LED printed circuit board of an embodiment of the present invention taken along the section plane 51 in FIG. 31 and FIG. 32.

FIG. 35 is a pictorial cutaway view of a bent LED printed circuit board of an embodiment of the present invention taken along the section plane 52 in FIG. 31 and FIG. 32.

FIG. 36 is a pictorial representation of a sub-assembly of an embodiment of the present invention.

FIG. 37 is a pictorial representation of a sub-assembly of an embodiment of the present invention, with showing section planes position from perspective view.

FIG. 38 is a pictorial representation of a sub-assembly of an embodiment of the present invention, with showing section planes position from top view.

FIG. 39 is a pictorial cutaway view of a sub-assembly of an embodiment of the present invention taken along the section plane 55 in FIG. 37 and FIG. 38.

FIG. 40 is a pictorial cutaway view of a sub-assembly of an embodiment of the present invention taken along the section plane 56 in FIG. 37 and FIG. 38.

FIG. 41 is a pictorial cutaway view of a sub-assembly of an embodiment of the present invention taken along the section plane 57 in FIG. 37 and FIG. 38.

FIG. 42 is a pictorial cutaway view of a sub-assembly of an embodiment of the present invention taken along the section plane 58 in FIG. 37 and FIG. 38.

FIG. 43 is a pictorial representation of a body 20 of an embodiment of the present invention.

FIG. 44 is a pictorial cutaway view of a body 20 of an embodiment of the present invention.

FIG. 45 is a pictorial representation of a sub-assembly of the present invention showing magnified view section plane 53.

FIG. 46 is a pictorial magnified view of a sub-assembly of the present invention, taken along the section plane 53 in FIG. 45.

FIG. 47 is a pictorial representation of FIG. 46, showing section plane position from perspective view.

FIG. 48 is a pictorial representation of FIG. 46, showing section plane position from top view.

FIG. 49 is a pictorial cutaway view of FIG. 46, taken along the section plane 54 in FIG. 47 and FIG. 48.

FIG. 50 is a pictorial representation of an embodiment of the present invention, showing pin, mushroom head and iron head.

FIG. 51 is a pictorial representation of the second embodiment of the present invention, showing a different heat transfer surface 6.

FIG. 52 is a pictorial representation of the third embodiment of the present invention, showing different thermoplastic materials used on outer part and inner part.

FIG. 53 is a pictorial representation of the fourth embodiment of the present invention, showing grooves on vapor transport channel walls of outer part and inner part.

FIG. 54 is a pictorial cutaway view of the sixth embodiment of the present invention, which has drum shape outer part.

FIG. 55 is a pictorial cutaway view of the seventh embodiment of the present invention, which has umbrella shape outer part.

FIG. 56 is a pictorial cutaway view of the eighth embodiment of the present invention, which has additional heat transfer surface at top of the LED light bulb.

FIGS. 57 to 59 are a pictorial representation of the ninth embodiment of the present invention.

### DETAILED DESCRIPTION OF THE PREFERRED EMBODIMENTS

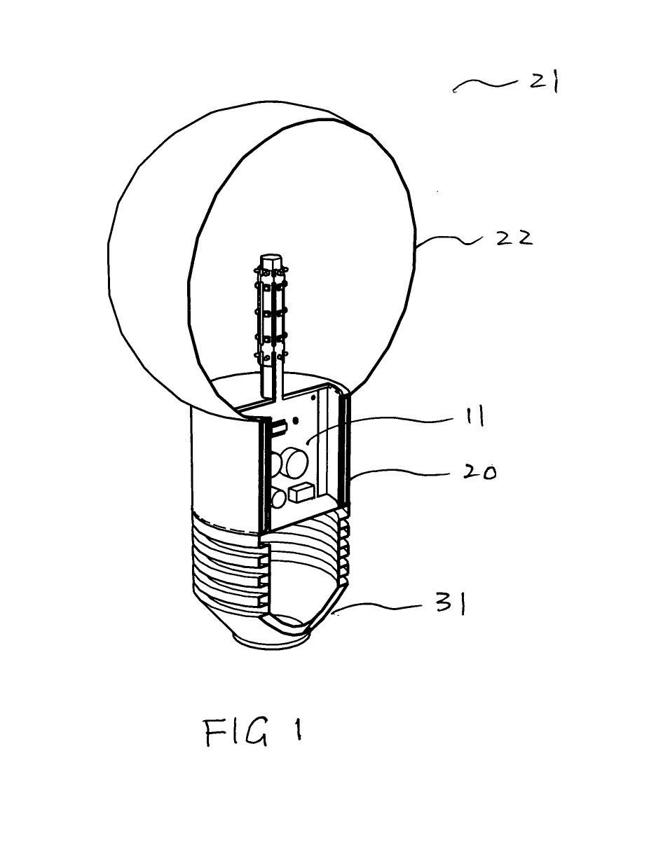

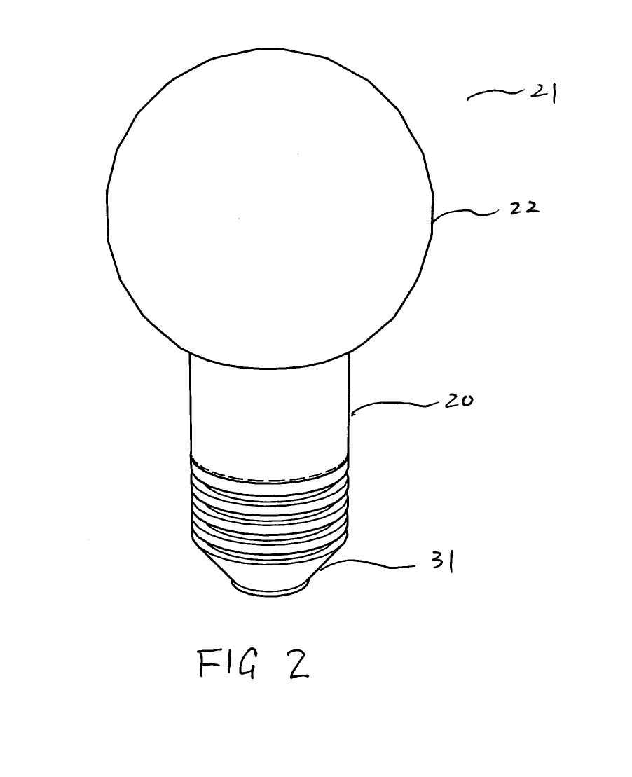

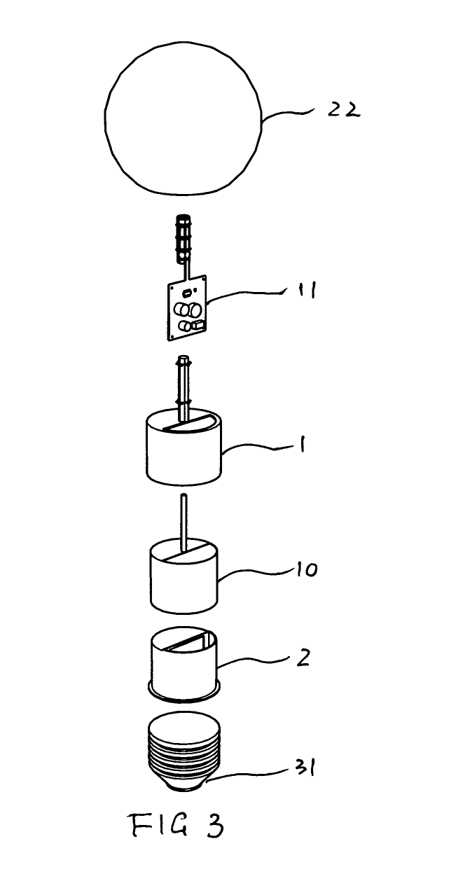

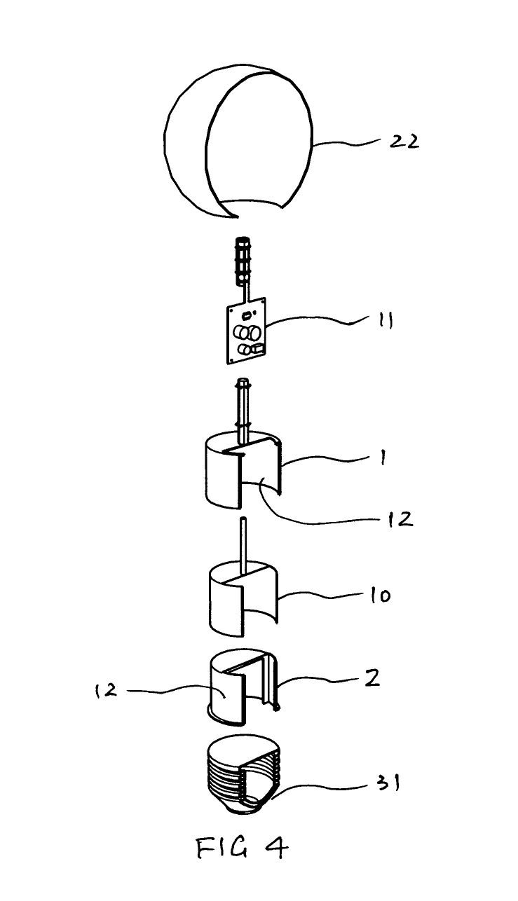

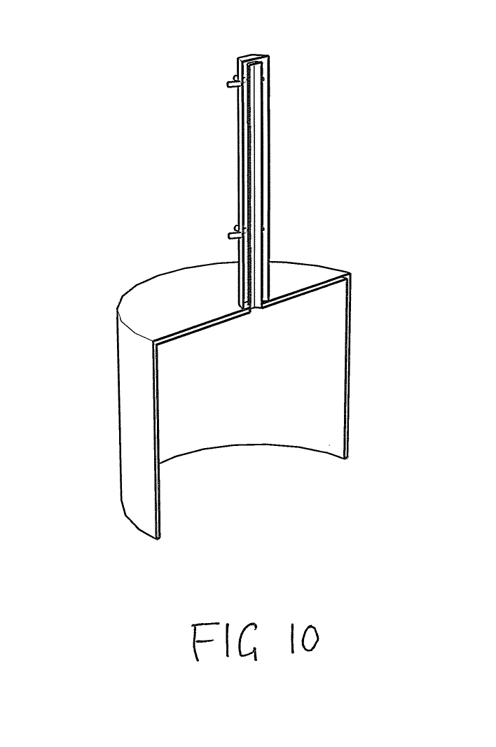

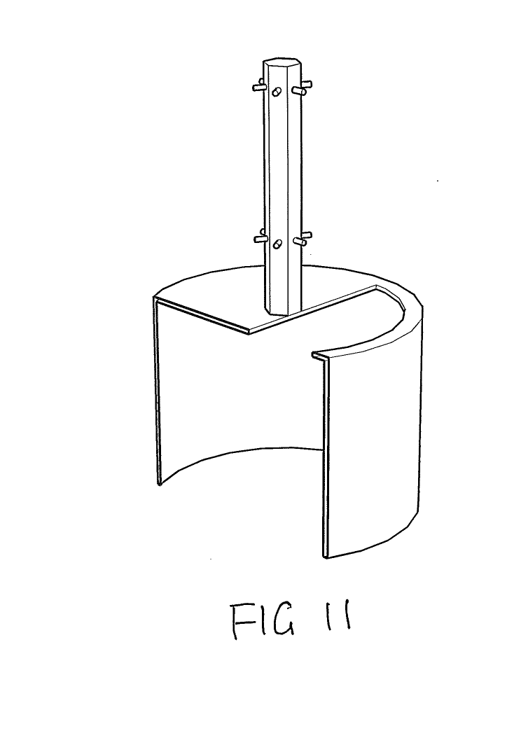

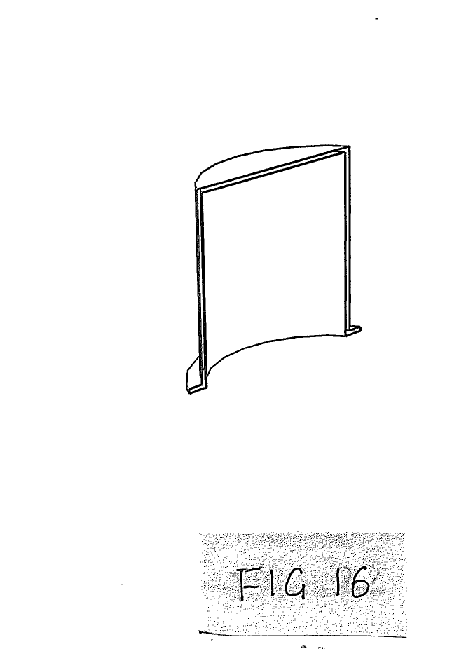

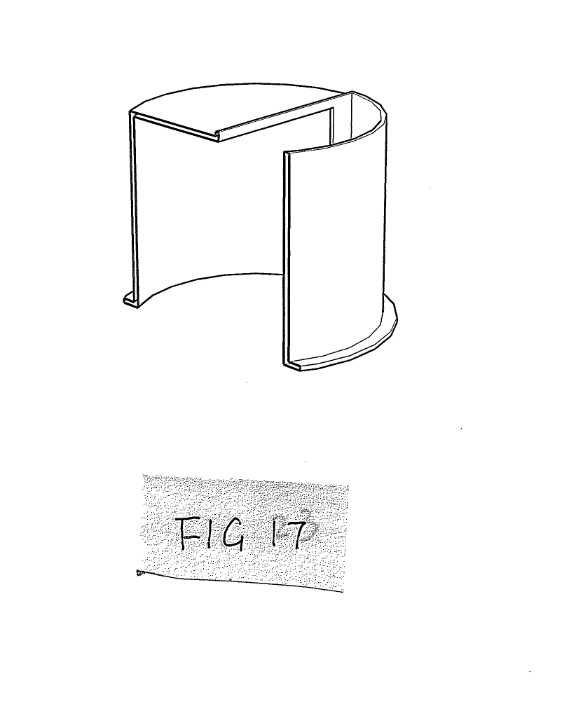

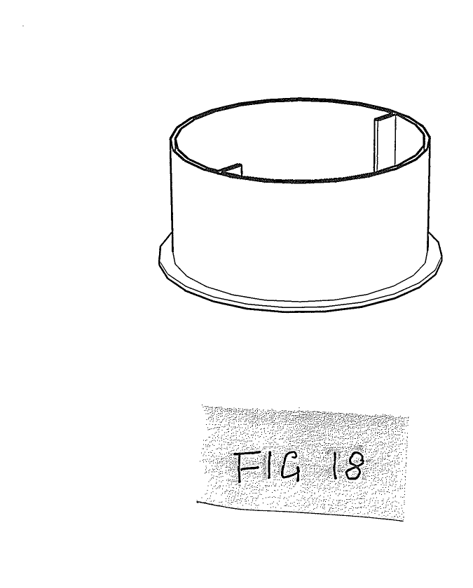

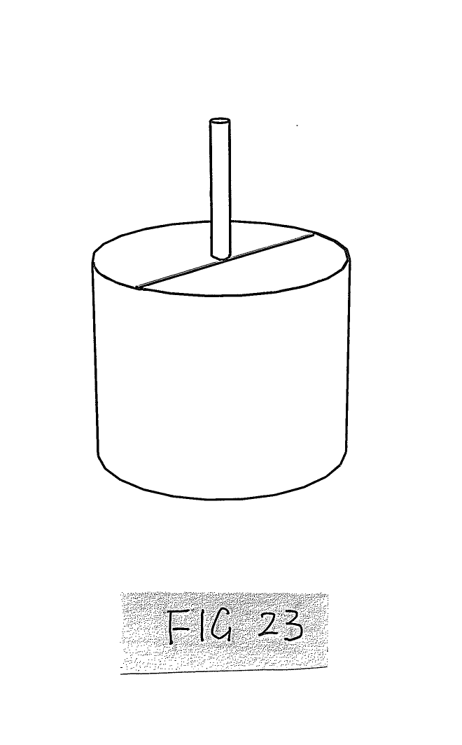

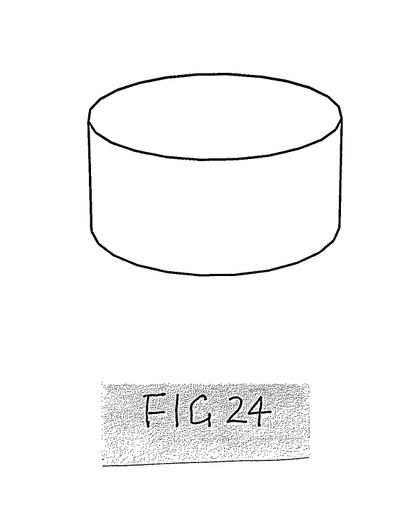

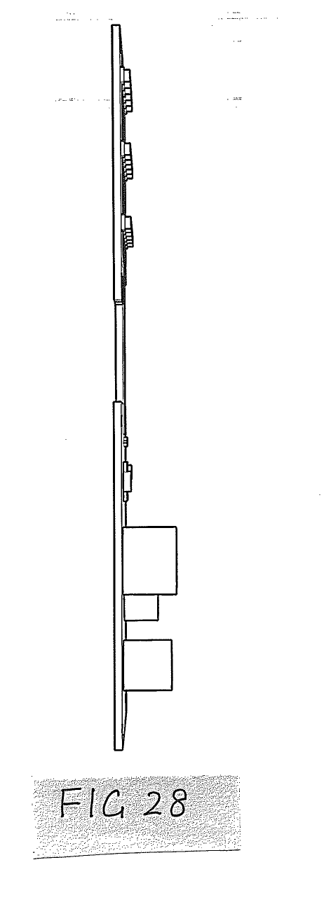

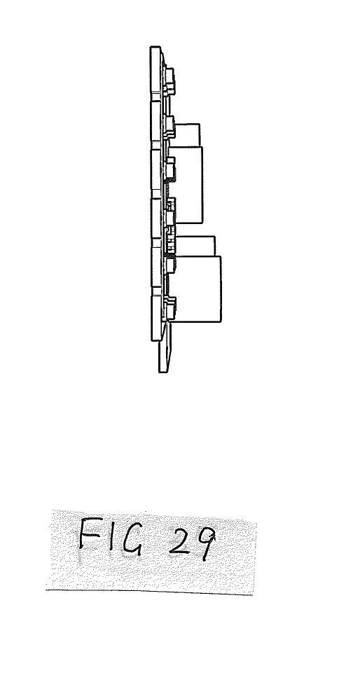

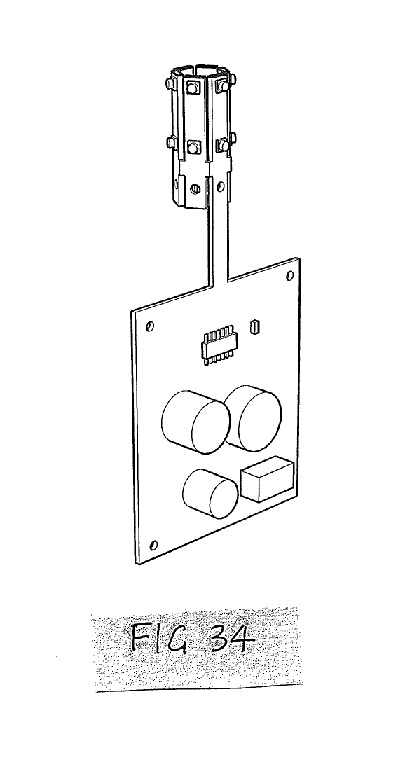

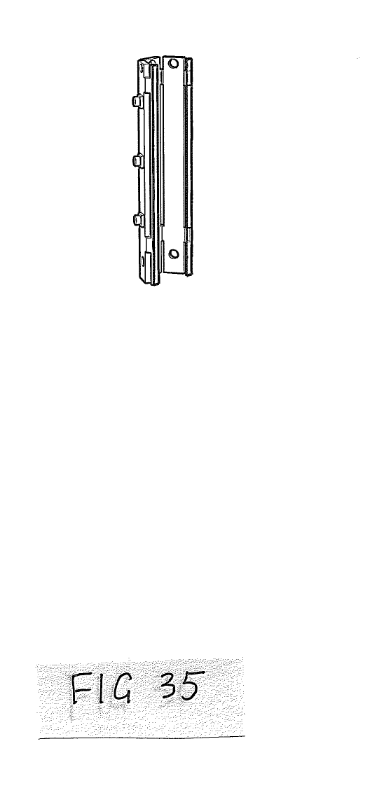

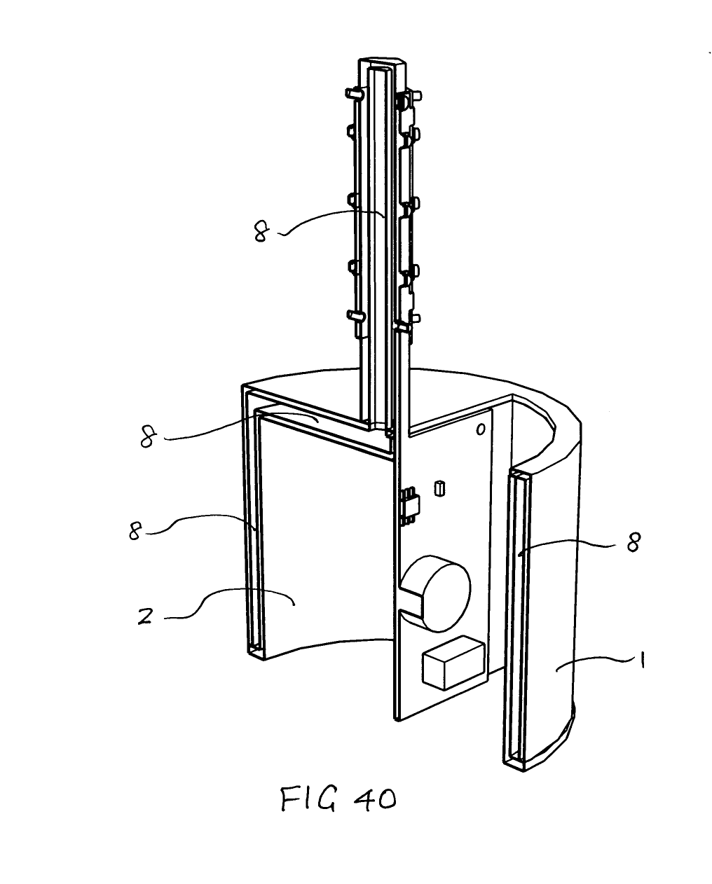

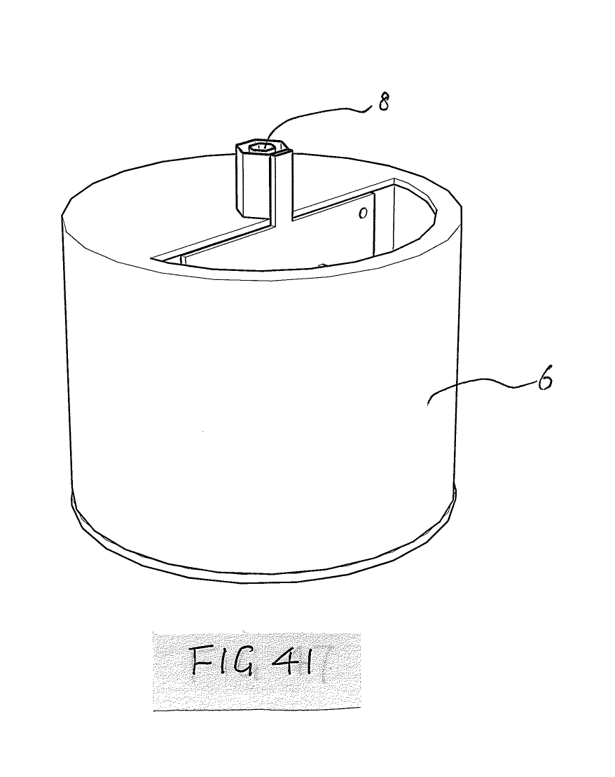

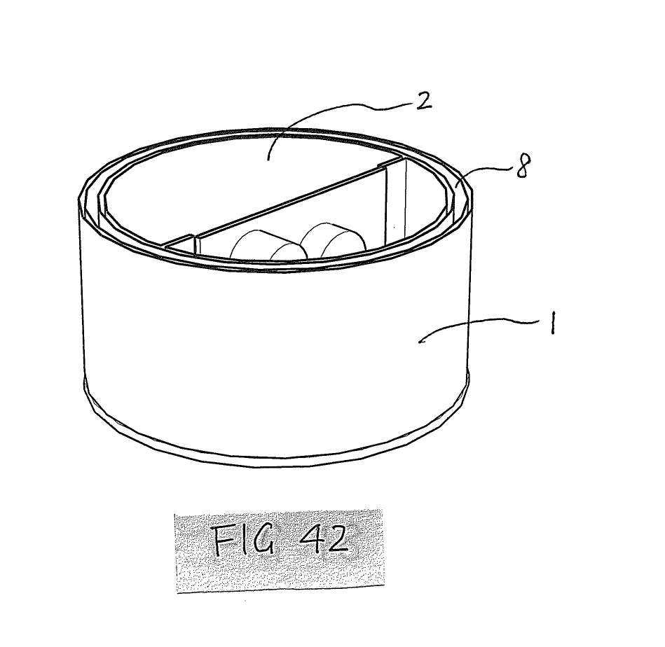

Please refer to FIGS. 1 to 50 for the first embodiment of the present invention.

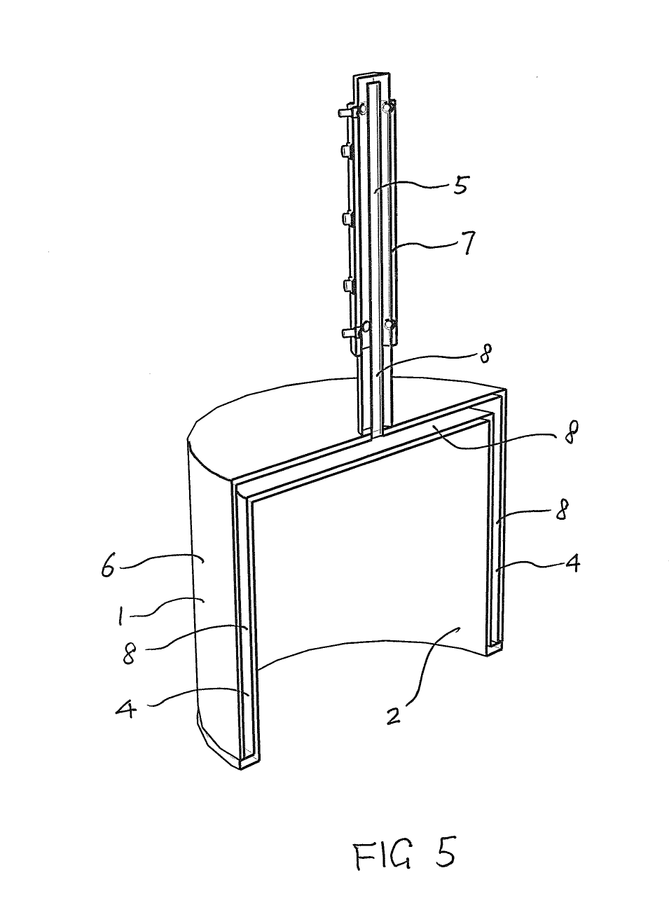

Please refer to FIGS. 1 to 5, a LED light bulb 21 of the present invention includes a cover 22, a LED printed circuit board 11, a body 20 and a base 31. Said body 20 consists of a outer part 1, a wick 10 and a inner part 2. Said cover 22 may be design to be transparent, translucent or a lens directing light direction, and sometime may be eliminated. Although the cover 22 and base 31 shown in FIGS. 1 to 5 are representing of a LED light bulb for retrofitting type A incandescent light bulb, the present invention may also be used with other types of base and cover, for example but not limited to halogen light bulb and HID light bulb. FIG. 5 shows a cutaway view of sub-assembly 26 of the present invention.

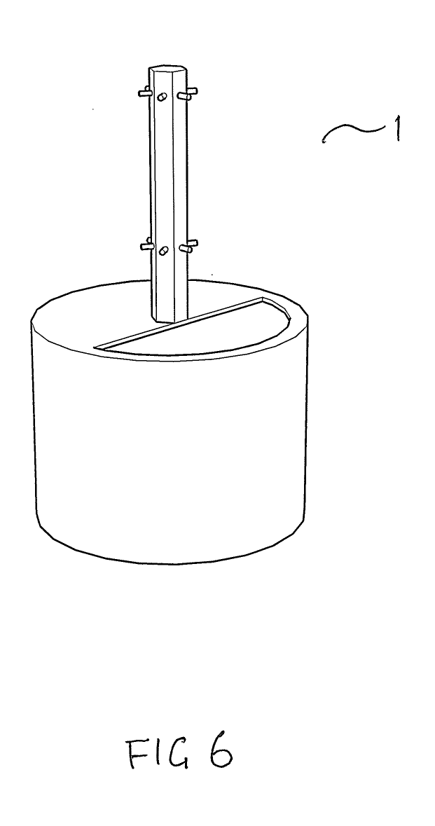

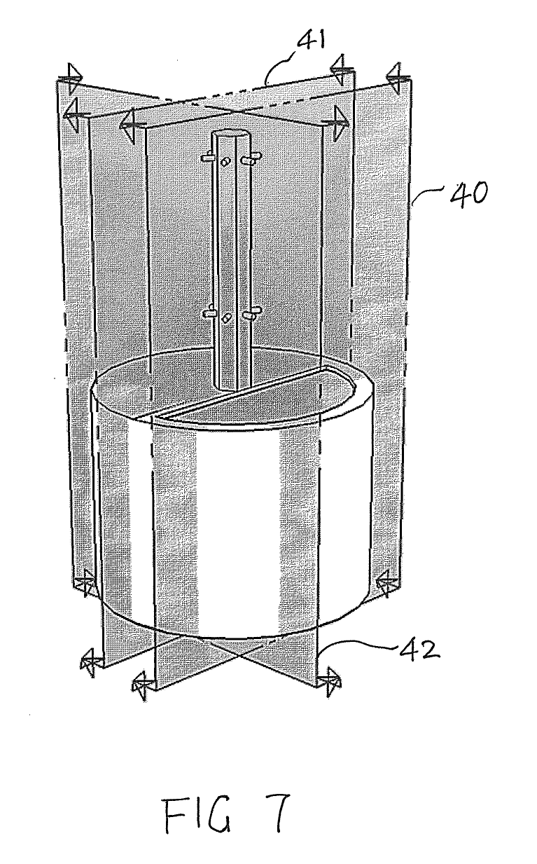

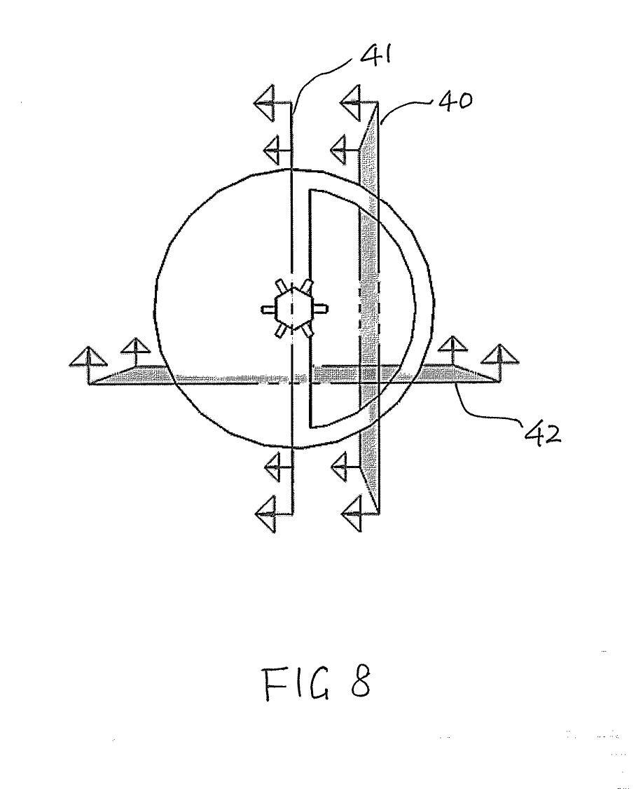

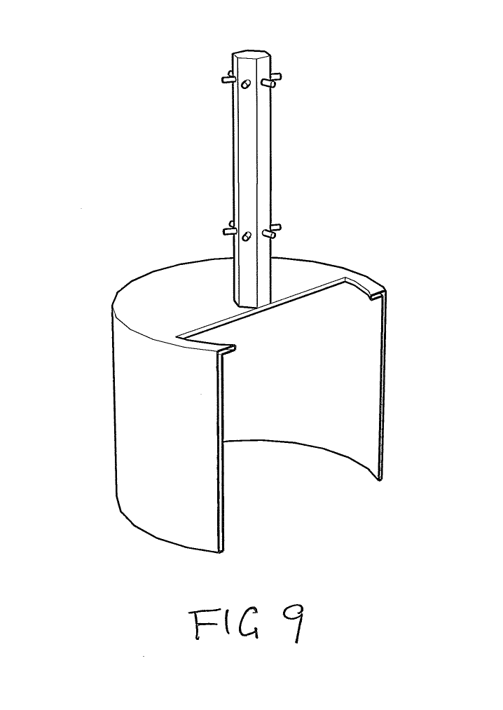

Please refer to FIGS. 6 to 11 regarding outer part 1. FIG. 6 shows the perspective view of outer part 1. FIGS. 7 and 8 show section planes position of outer part 1 from perspective view and top view respectively. FIGS. 9 to 11 show sectional view of outer part 1 along section plane 40 to 42 respectively.

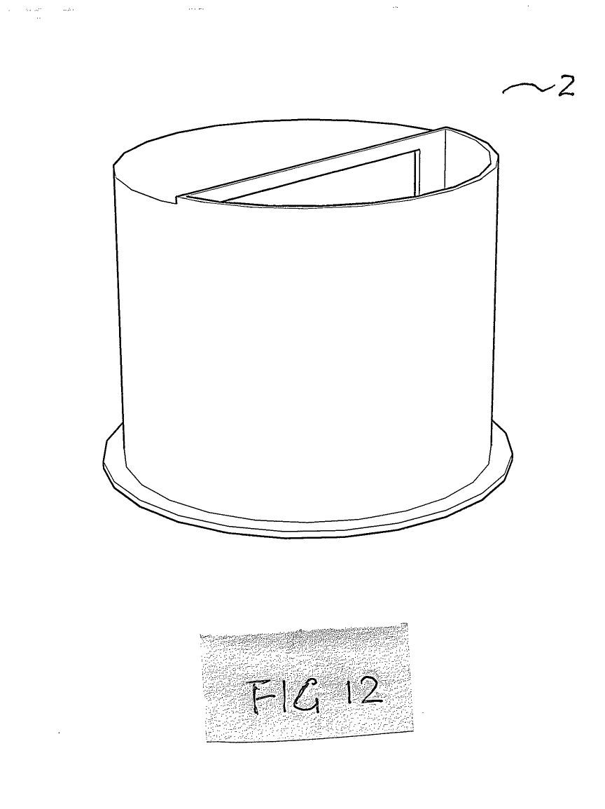

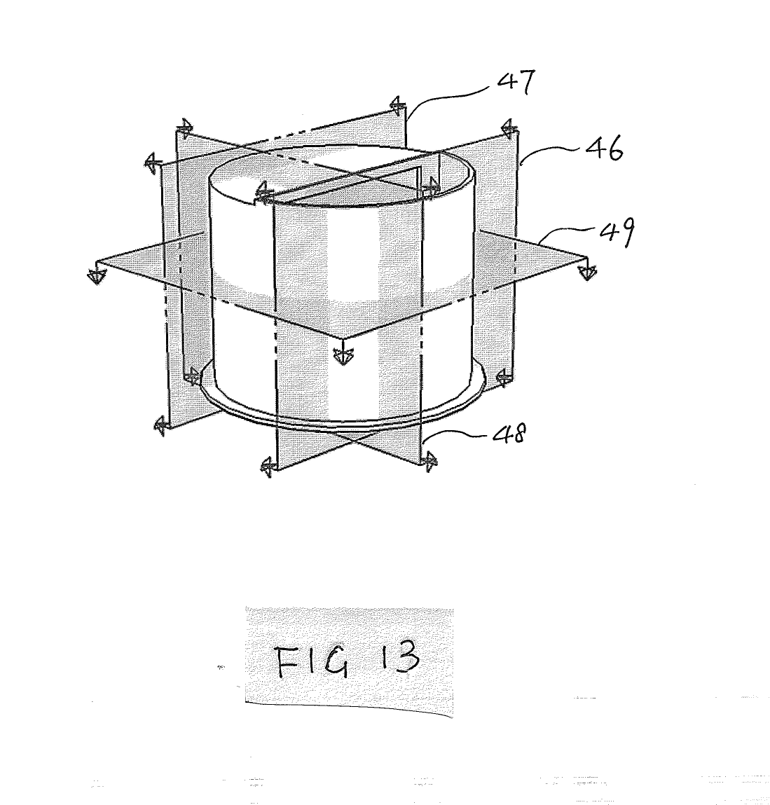

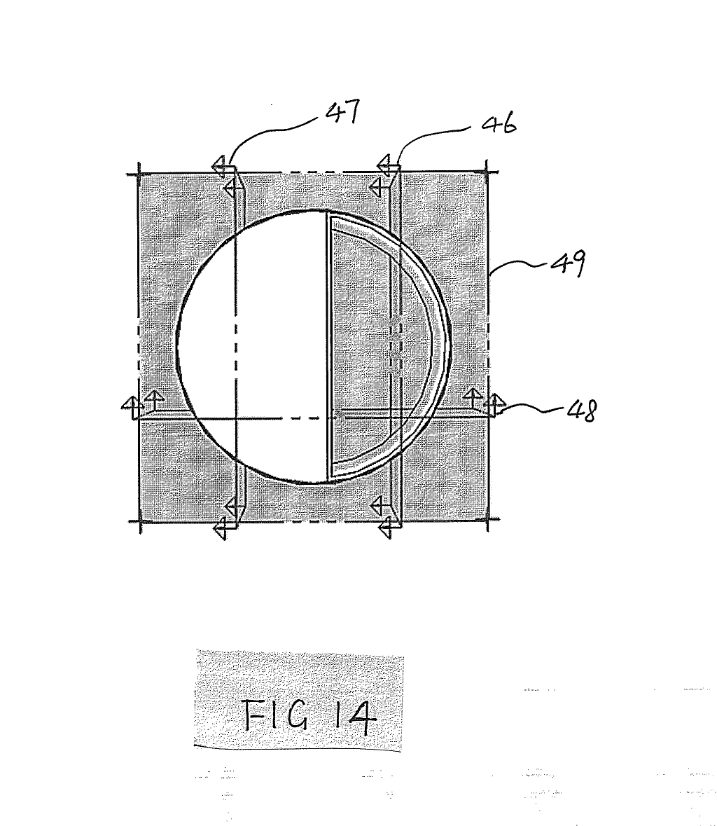

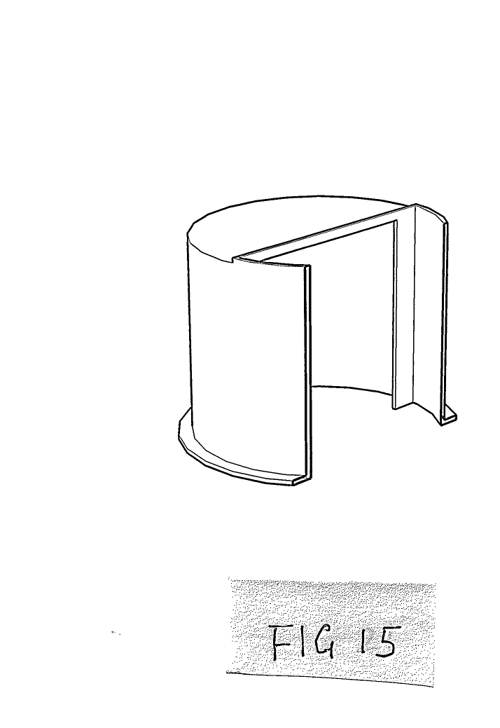

Please refer to FIGS. 12 to 18 regarding inner part 2. FIG. 12 shows the perspective view of inner part 2. FIGS. 13 and 14 show section planes position of inner part 2 from perspective view and top view respectively. FIGS. 15 to 18 show sectional view of inner part 2 along section planes 46 to 49 respectively.

The outer part 1 and inner part 2 may be made with same thermal conductive plastic material. One example of such thermal conductive plastic material is D1202, thermally conductive and dielectric PP, 5 W/mK, made by Cool Polymers, Inc. Other thermal conductive plastic materials with thermal conductivity over 0.5 W/mK are also viable. The thermal conductive plastic material is made by adding thermal conductive fillers into the regular thermoplastic resin to change its thermal conductivity. The common fillers used include ceramic, carbon and metal powders. The thermal conductive plastic material usually costs much higher than regular thermoplastic material.

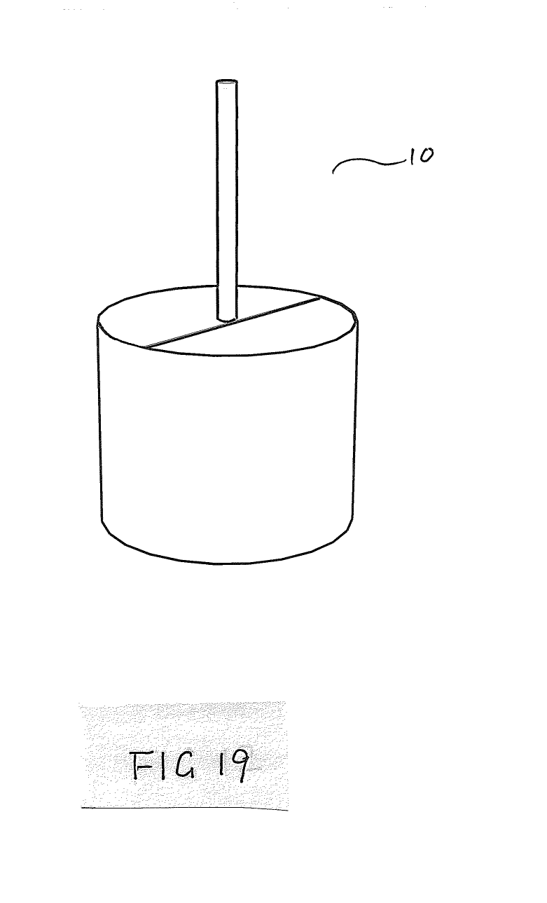

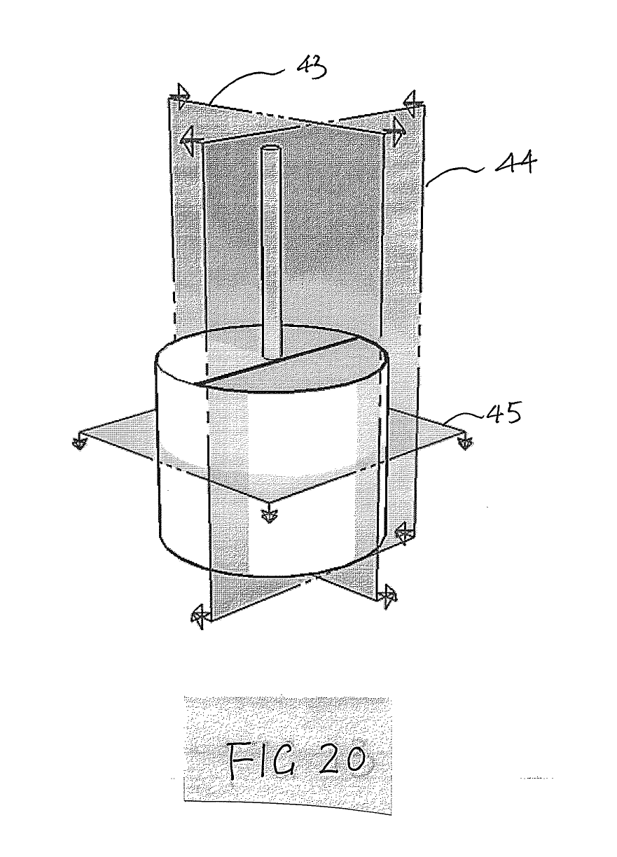

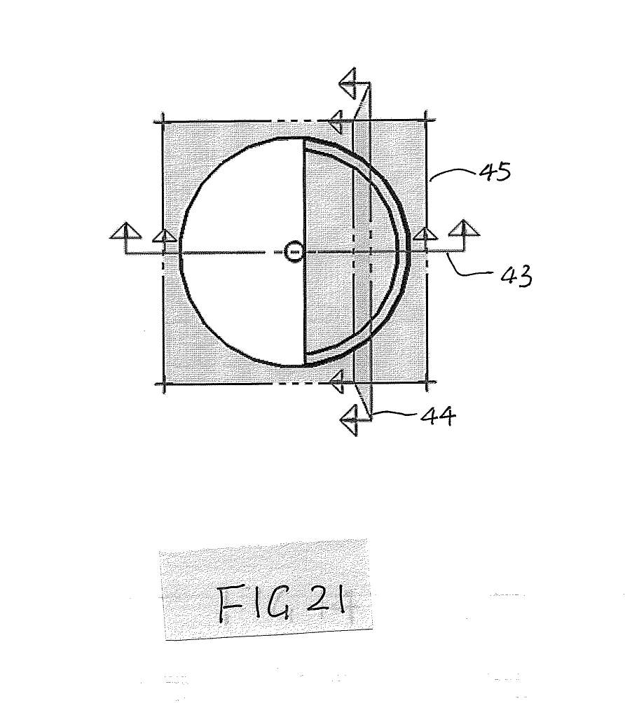

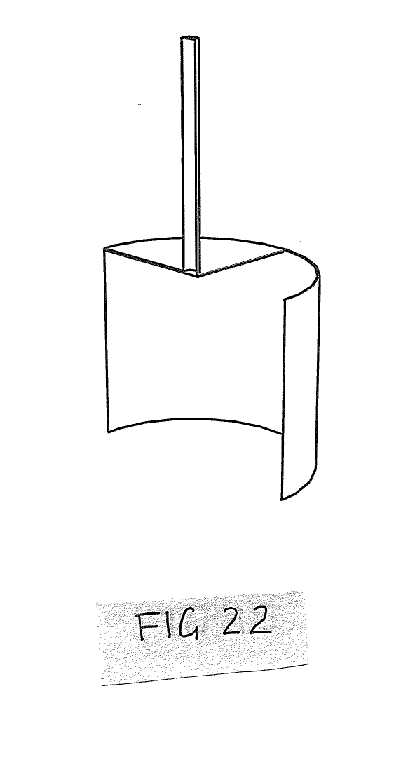

Please refer to FIGS. 19 to 24 regarding wick 10. FIG. 19 shows the perspective view of wick 10. FIGS. 20 and 21 show section planes position of wick 10 from perspective view and top view respectively. FIGS. 22 to 24 show sectional view of wick 10 along section plane 43 to 45 respectively. The wick 10 may be formed outside the body and inserted into vapor transport channel 8 before the body sealed closed. The shape of wick 10 is not limited to which shown in FIGS. 19 to 24. It is viable to any shapes as long as the wick extended between the two heat transfer locations 6, 7 and only fills partial of the vapor transport channel 8, leaves passing through space for vaporized gas flow from vapor end 5 to condense end 4. The wick can be made from conventional copper heat pipe wick materials, include powder metal, mesh or fiber. One example of the wick material is Scott Naturals paper towels, made by Kimberly-Clark Corporation.

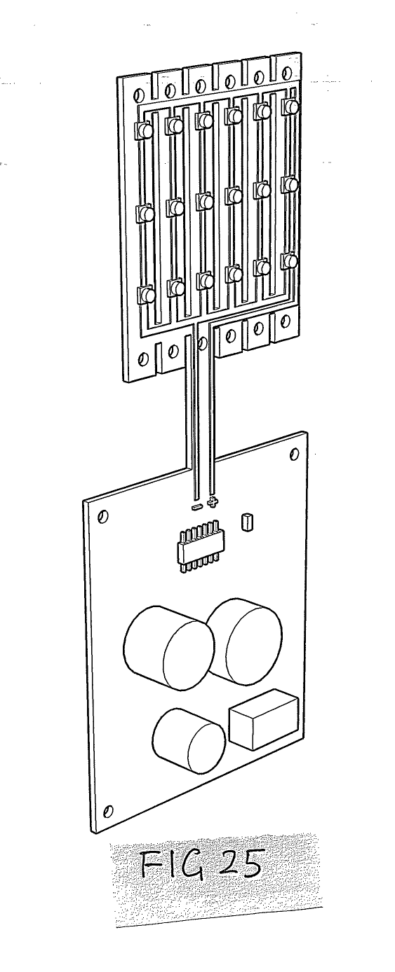

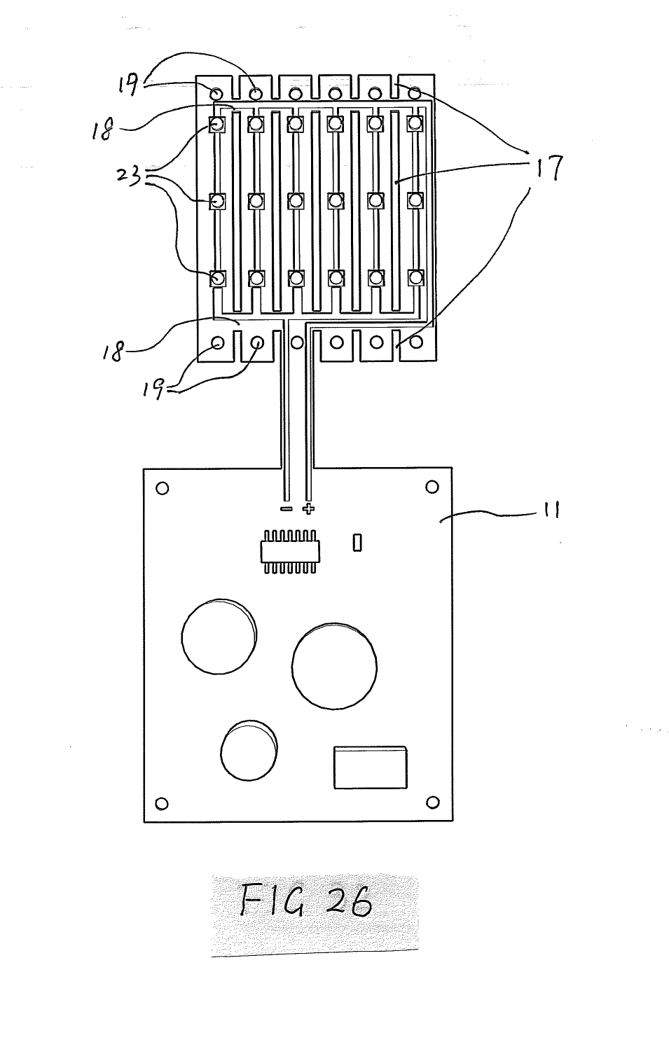

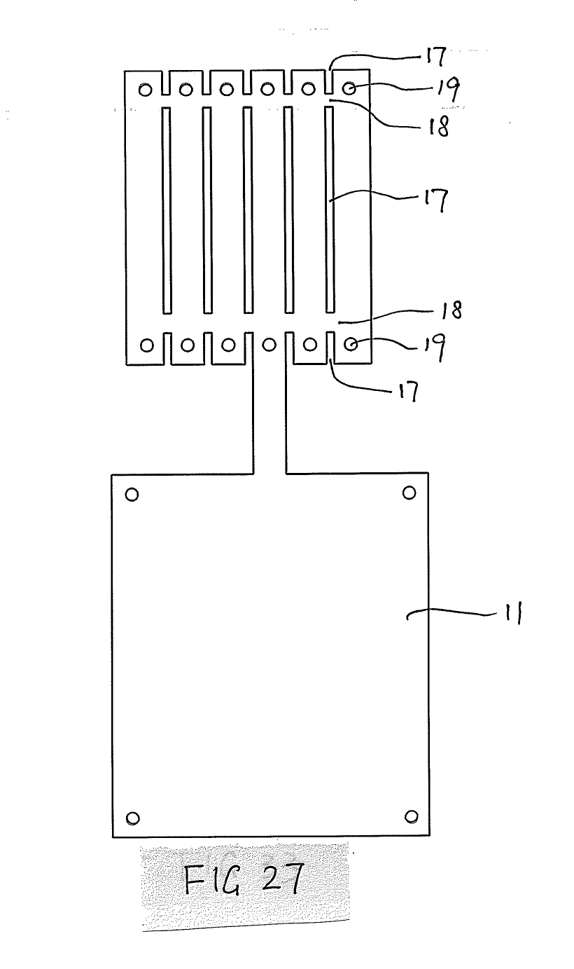

Please refer to FIGS. 25 to 29 regarding a LED printed circuit board 11. FIG. 25 shows the perspective view of a LED printed circuit board 11. FIGS. 26 to 29 show front, back, left and top view of a LED printed circuit board 11 respectively. The LED printed circuit board 11 includes open slots 17 along the LEDs 23 as shown in FIGS. 26 and 27. When bend and mount said LED printed circuit board 11 on body 20, the deformed area of said LED printed circuit board 11 will be limited to locations 18, the top layer copper traces above said locations 18 will be slightly stretched but will not break. The areas of said LED printed circuit board 11 where underneath LEDs 23 won't become curved shape, thus LEDs 23 soldering points won't experience deform stress. The material used for LED printed circuit board 11 is preferable but not limited to FR4, the glass-reinforced epoxy laminate sheets, a common printed circuit board material. Aluminum based printed circuit board material can also be used. The thickness of the LED printed circuit board is preferable but not limited to 20 mil with 1 layer or 2 layers copper. The thickness of copper layer is preferable to be more than 0.5 oz to avoid circuitry damaging may caused by bending process. The backside of the LED printed circuit board may be V scored along locations 18 to ease bending process. The PCB layout of LED printed circuit board 11 is not limited to which shown in FIGS. 25 to 29. The number of LED strings or number of LEDs on each string may be flexible to choose, it is viable as long as the LEDs 23 located on the portion of said LED printed circuit board 11 which mounted on top of heat transfer surface 7 of said body 20.

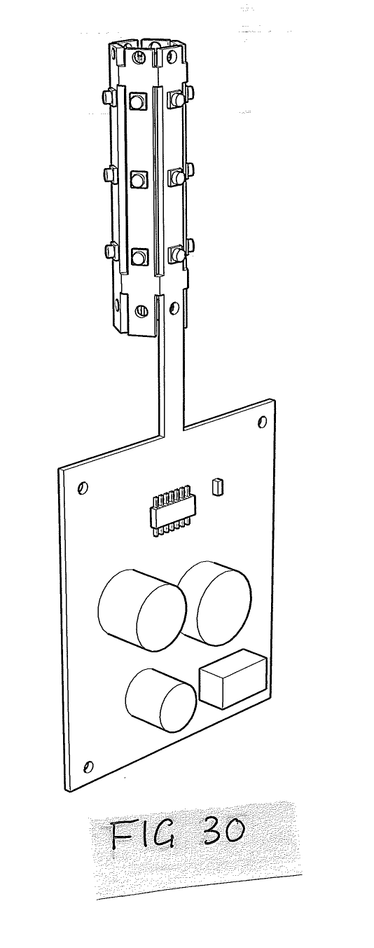

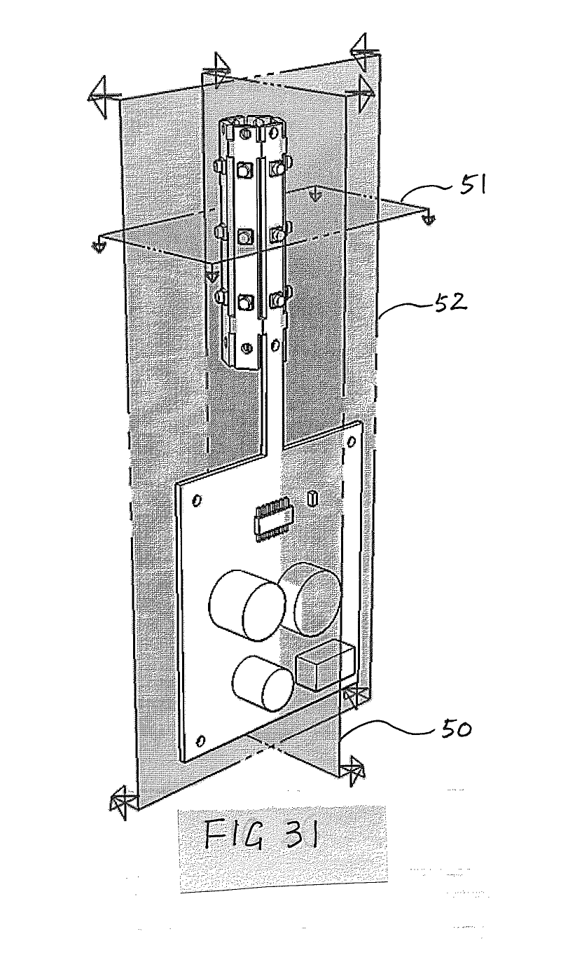

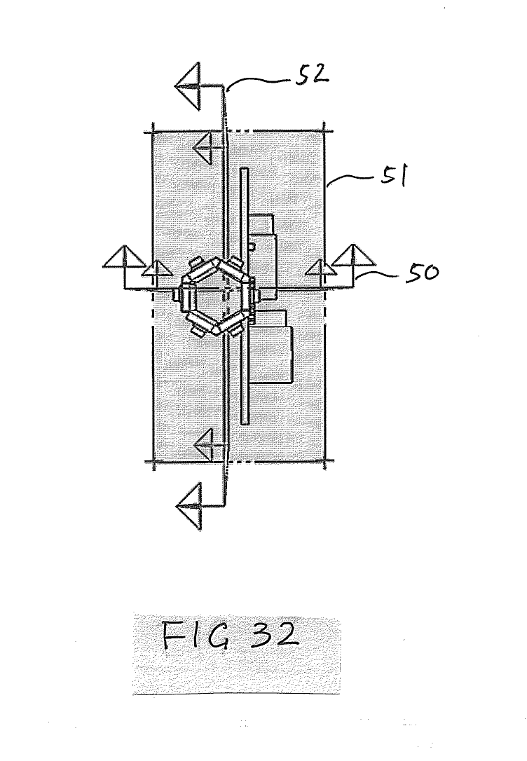

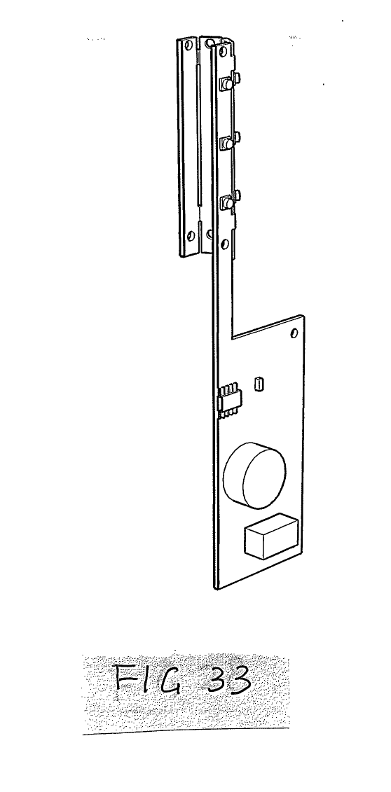

Please refer to FIGS. 30 to 35 regarding a bent LED printed circuit board 11. FIG. 30 shows the perspective view of a bent LED printed circuit board 11. FIGS. 31 and 32 show section planes position of a bent LED printed circuit board 11 from perspective view and top view respectively. FIGS. 33 to 35 show sectional view of a bent LED printed circuit board 11 along section planes 50 to 52 respectively.

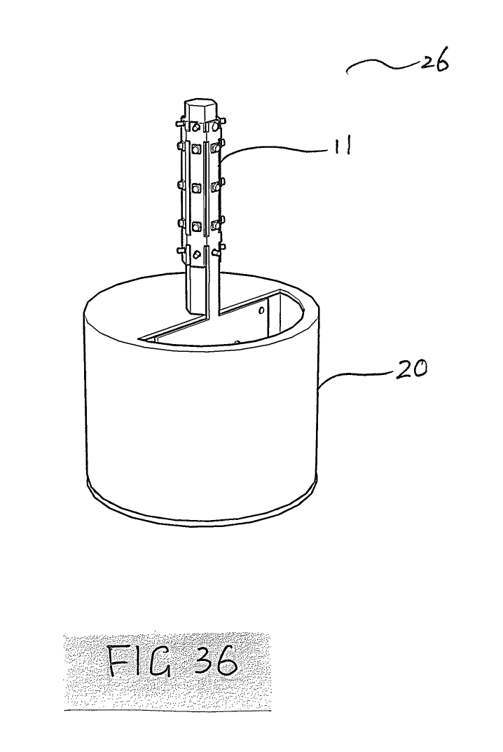

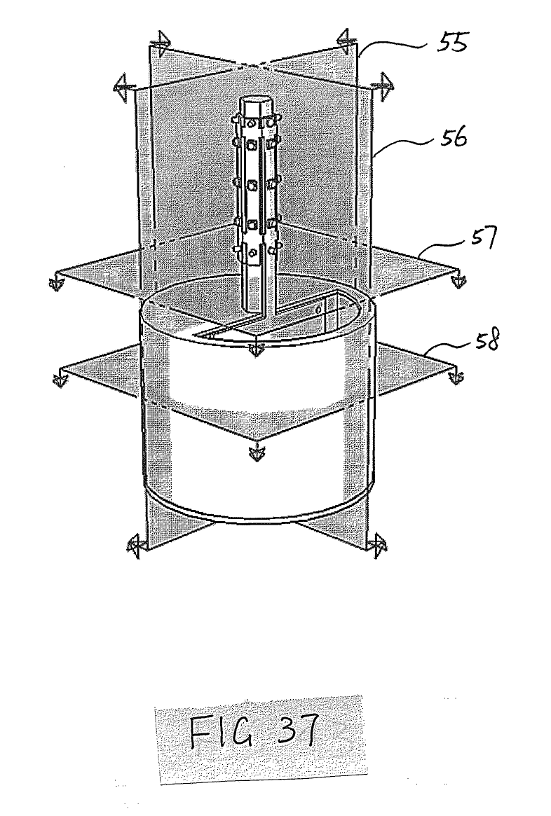

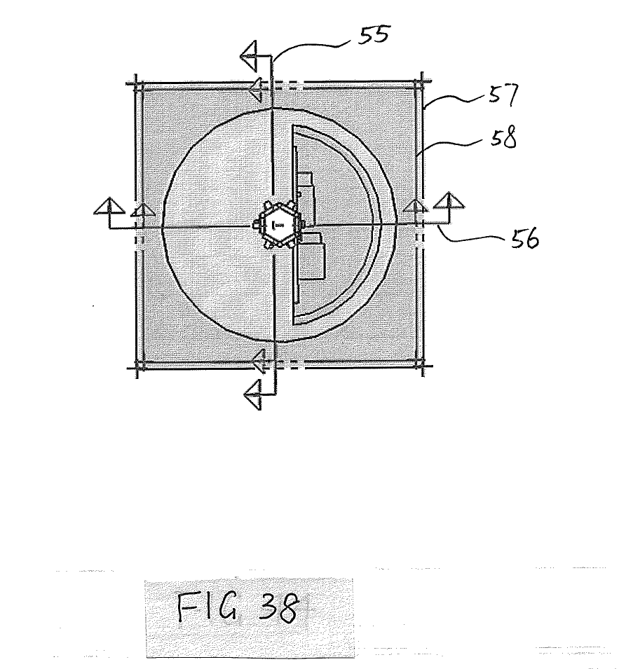

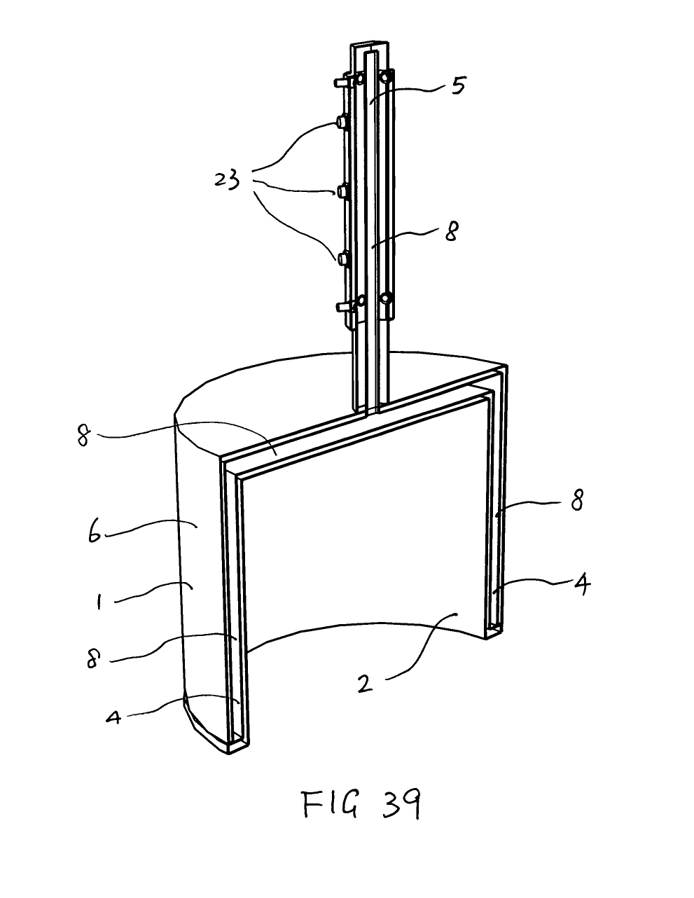

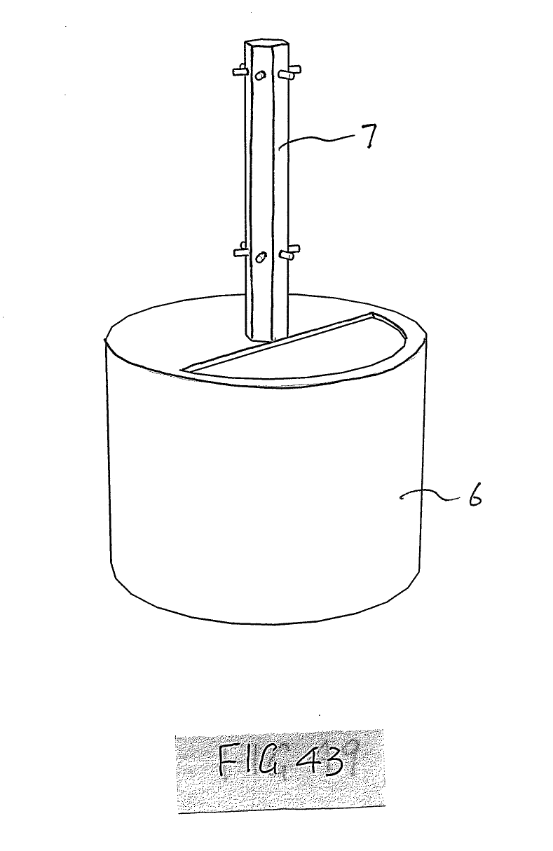

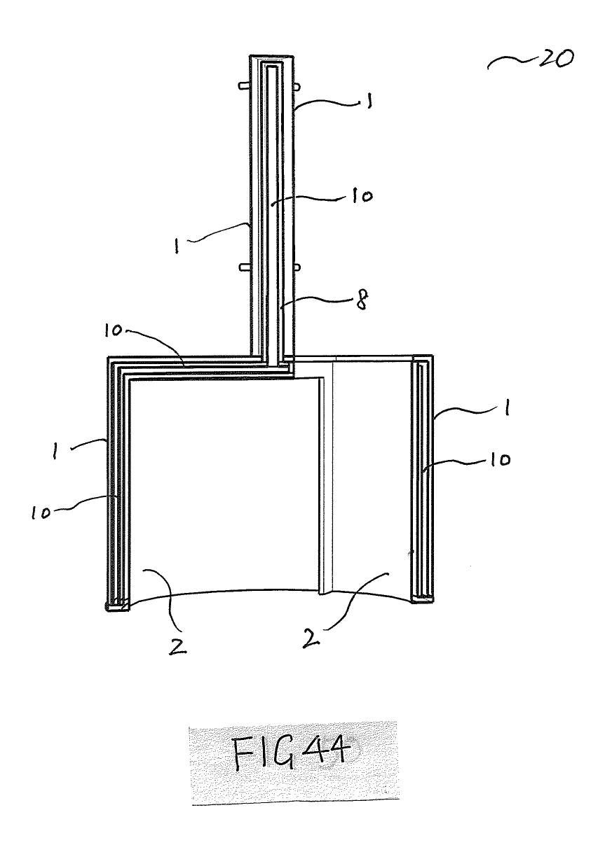

Please refer to FIGS. 36 to 44 regarding sub-assembly 26 consists of a LED printed circuit board 11 mounted on a body 20. FIG. 36 shows the perspective view of sub-assembly 26. FIGS. 37 and 38 show section planes position of sub-assembly 26 from perspective view and top view respectively. FIGS. 39 to 42 show sectional view of sub-assembly 26 along section planes 55 to 58 respectively. FIG. 43 shows the perspective view of body 20. FIG. 44 shows the perspective cutaway view of body 20. The body 20 includes outer part 1 and inner part 2 made of thermoplastic material, formed a vapor transport channel 8 that extends between two heat transfer locations 6, 7 spaced apart on an exterior surface of said outer part 1, a wick 10 locates inside said vapor transport channel 8 and extends between said two heat transfer locations 6, 7, and a working fluid 9 partially fills said vapor transport channel 8. A LED printed circuit board 11 may be mounted directly on said body 20. The portion of said LED printed circuit board 11 where LEDs 23 located, mounted on the heat transfer location 7. The other heat transfer location 6 may be exposed to a cooler temperature. So the heat transfer operation of the body 20 is like a conventional heat pipe.

The vapor transport channel 8 extends between the two heat transfer locations 6, 7. In operation the vaporized working fluid (vaporized by the heat from the LEDs 23 in vapor end 5 at heat transfer location 7) moves through the vapor transport channel 8 to condense end 4 at heat transfer location 6 where the vapor condenses. The shape of the vapor transport channel is not limited to any particular geometry. The shape of said vapor transport channel 8 is not limited to which shown in FIGS. 36 to 44. It is viable to any shape as long as the vapor transport channel 8 extended between two heat transfer locations 6, 7 and a continuous vapor transport channel to be maintained through the body 20 between the vapor end 5 and the condense end 4 in order to allow vapor to move freely between the two regions. The pressure gradient inside the vapor transport channel impels the vapor from the ‘hot spot’ toward other locations where condensation can occur at a slightly lower temperature.

The working fluid 9 only partially fills the vapor transport channel 8 inside the body 20 so there is open space for vapor transport between the heat transfer locations. The wick 10 conveys the condensate back to the heat transfer location 7 by capillary action and the cycle is repeated. The interior of said vapor transport channel 8 preferably is evacuated before the working fluid is introduced in order to maximize the efficiency of the heat transfer as residual gas inside the vapor transport channel will interfere with the vapor transport within the device. Evacuate the vapor transport channel 8 may also lower said working fluid 9 phase change temperature point. It is preferable but not limited to use distilled water as working fluid. It is also viable to use alcohol or other liquids as working fluid based on the thermoplastic materials and application temperature range requirement.

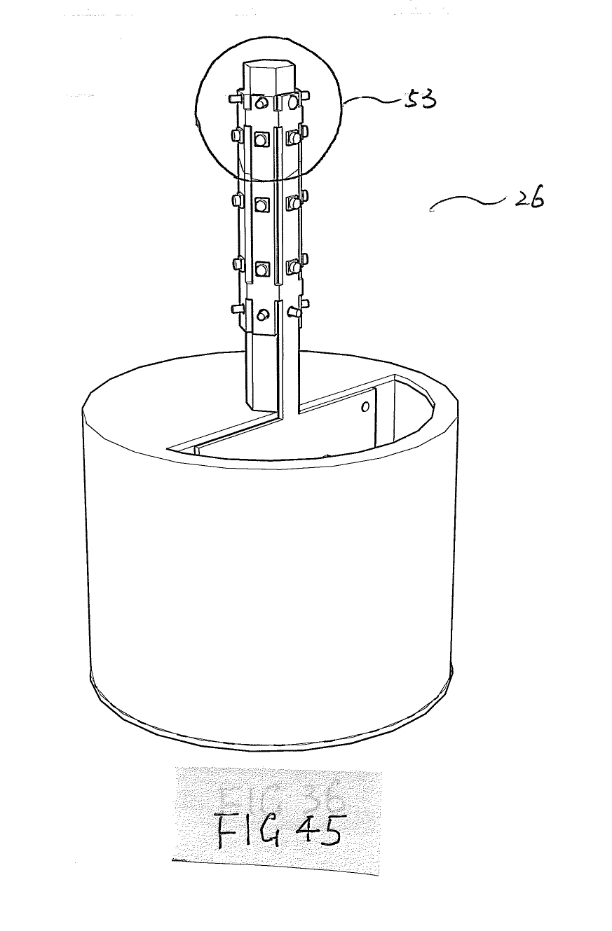

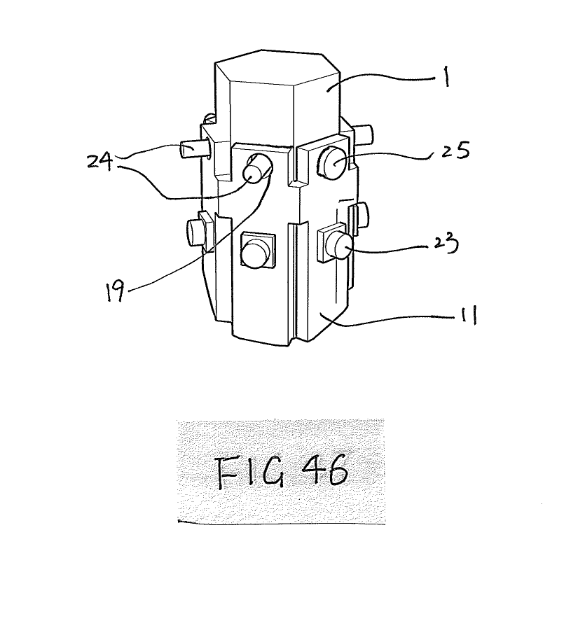

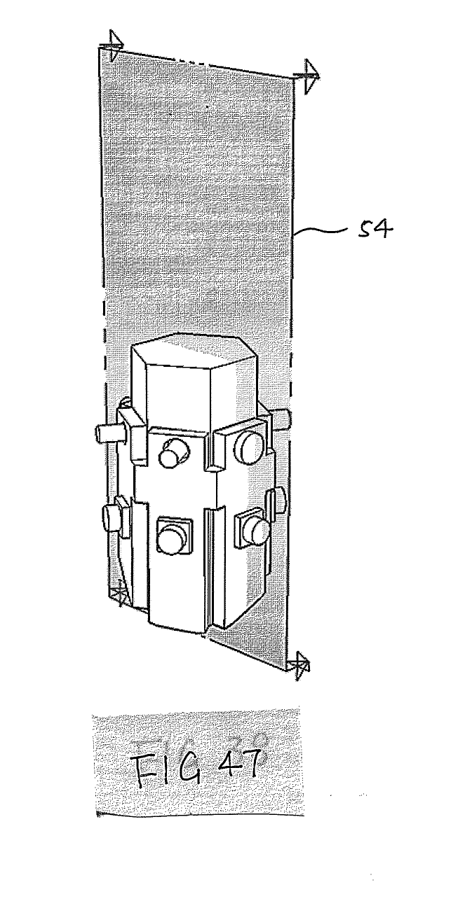

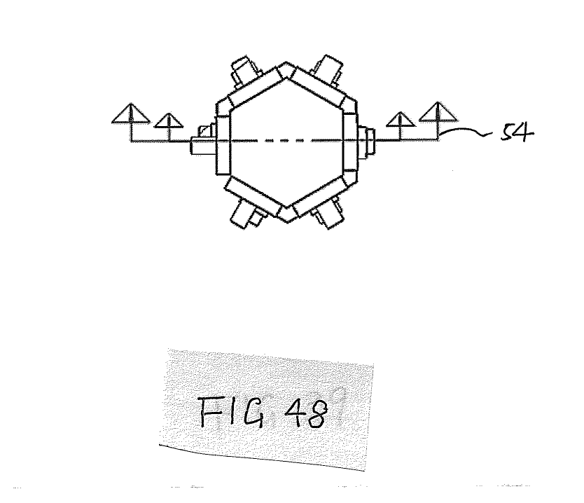

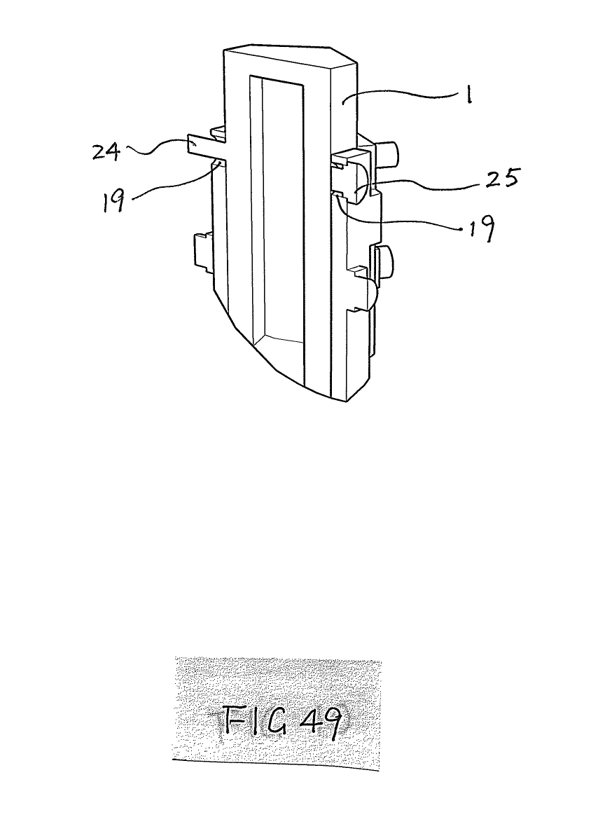

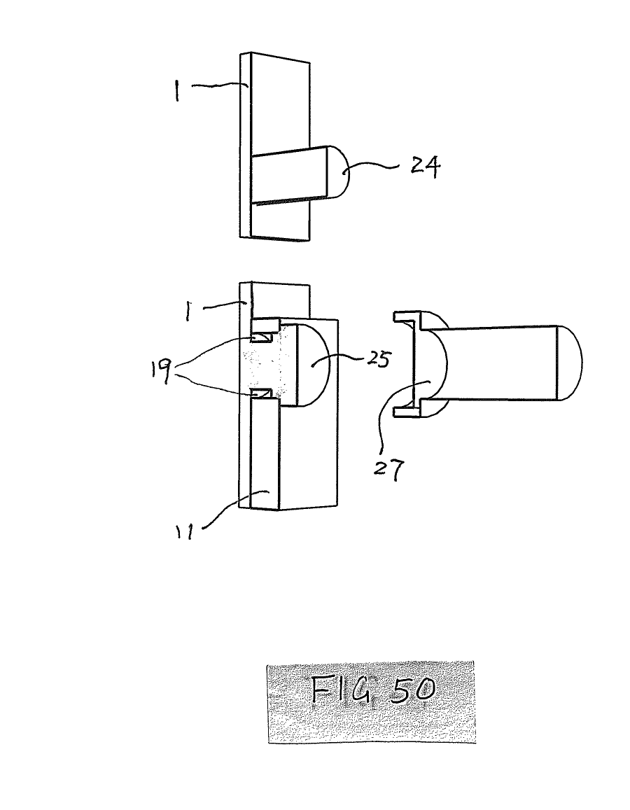

Please refer to FIGS. 45 to 50 regarding mounting holes and pins. FIG. 45 shows the magnified view section plane 53 position of a sub-assembly 26. FIG. 46 shows magnified view along section plane 53 shown in FIG. 45. FIGS. 47 and 48 show section plane position of magnified view in FIG. 46 from perspective view and top view respectively. FIG. 49 shows sectional view of magnified view in FIG. 46 along section plane 54. FIG. 50 shows the pin 24, mushroom head 25 and iron head 27.

When a LED printed circuit board 11 being bent and mounted on body 20, the mounting holes 19 of said LED printed circuit board 11 are positioned on respective pins 24 of said body 20. All said pins 24 being heated by iron head 27 to form mushroom heads 25, said mushroom heads 25 fix the LED printed circuit board 11 in place permanently. For demonstration purpose, only one mushroom head 25 is shown. The shape of said mushroom head 25 is defined by said iron head 27. Said iron head 27 and mushroom head 25 are not limited to the shape shown in FIGS. 45 to 50, it is viable to be any shape as long as the mushroom head 25 partially fills and extends outside the mounting hole 19.

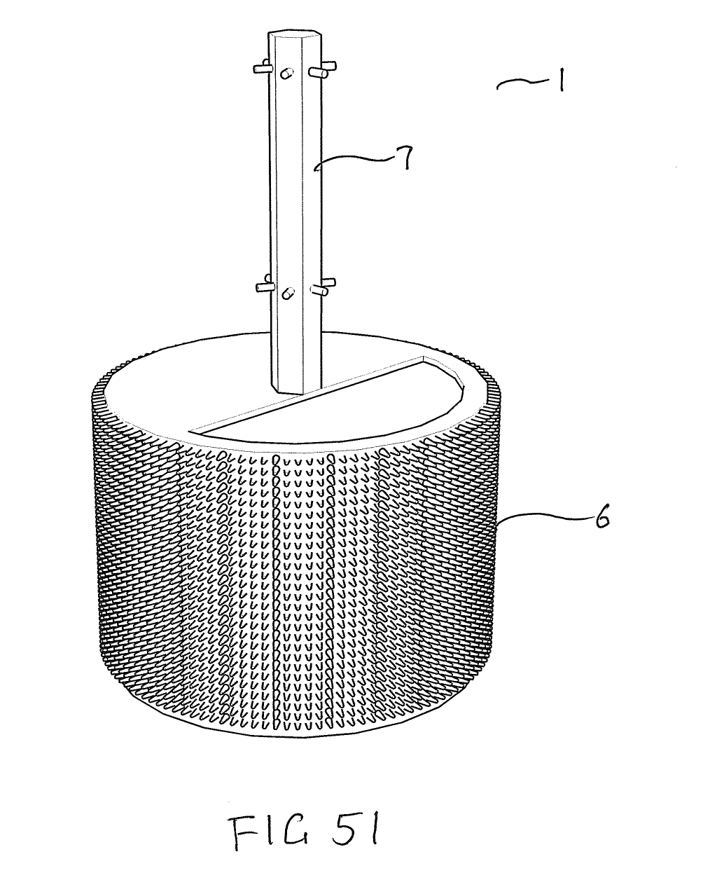

Please refer to FIG. 51 for the second embodiment of the present invention. The heat transfer surface 6 on outer part 1 of the first embodiment of the present invention may be processed to be shown in FIG. 51. Due to increased surface area of said heat transfer surface 6, the heat dissipation ability from said heat transfer surface 6 to surrounding environment will be greatly improved. Said process may be done by machining after out part 1 fabricated, but it is preferable to have it integrated into the out part 1 design.

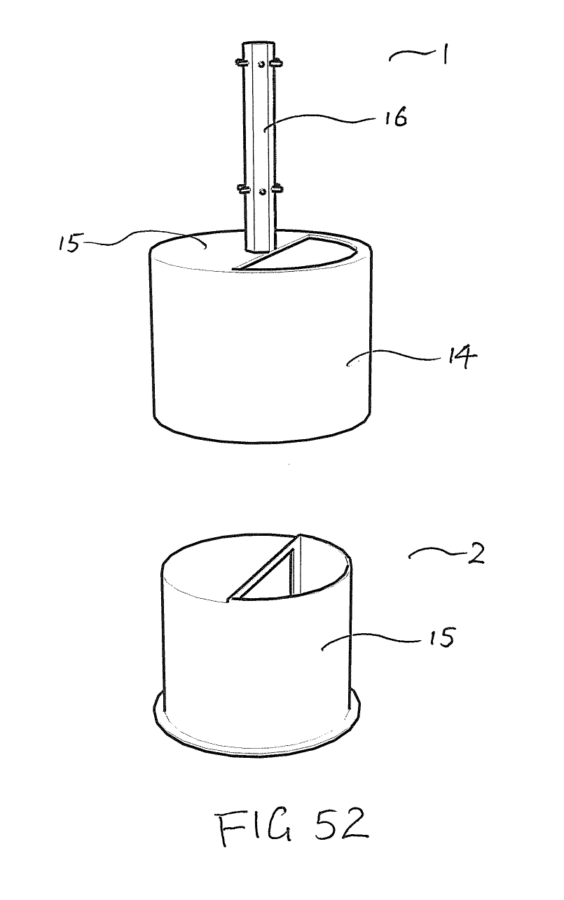

Please refer to FIG. 52 for the third embodiment of the present invention. The outer part 1 and inner part 2 of the first embodiment of the present invention may use different thermoplastic materials to further reduce material cost. The inner part 2 may be made with regular thermoplastic material 15, the heat transfer surface 7 portion of outer part 1 may be made with thermal conductive plastic material 16, the heat transfer surface 6 portion of outer part 1 may be made with thermal conductive plastic material 14, the rest portion of the outer part 1 may be made with regular thermoplastic material 15. One example of these materials are: regular thermoplastic material 15, polypropylene (PP), CAS number 9003-07-0, from PolyOne Corporation; thermal conductive plastic material 16, D1202, thermally conductive and dielectric PP, 5 W/mK, from Cool Polymers, Inc; thermal conductive plastic material 14, MT-210-14, thermally conductive PP, 1.1 W/mK, from SABIC Innovative Plastics Holding BV.

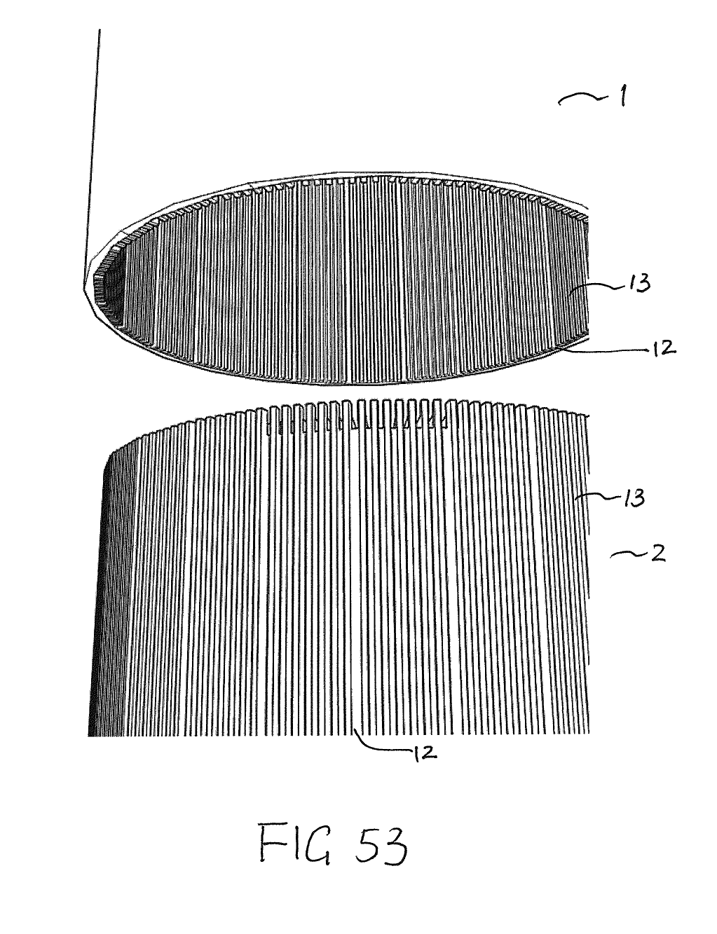

Please refer to FIG. 53 for the fourth embodiment of the present invention. Without use wick as working fluid transfer material in the first embodiment of the present invention, a plurality of grooves 13 may be integrated into the vapor transport channel walls 12. The grooves 13 extends between the two heat transfer locations 6, 7 and will function same as wick to conveys the condensate back to the heat transfer location 7 by capillary action.

In the fifth embodiment of the present invention, the inner part 2 of the first embodiment of the present invention may be made of thermally conductive electrically conductive material, achieving the electromagnetic field shielding function. One example of such thermoplastic material is: E1202, thermally conductive and dielectric PP, 10 W/mK, from Cool Polymers, Inc

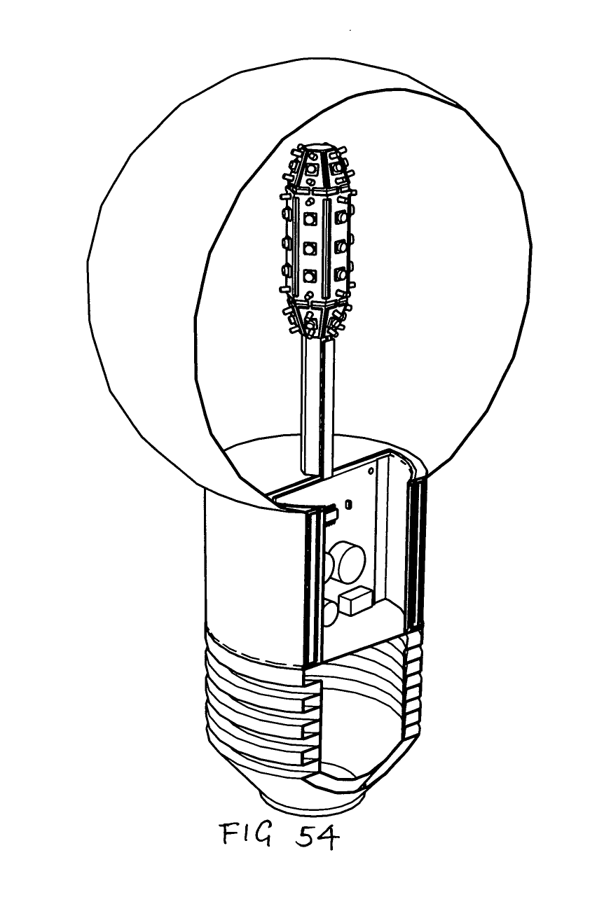

Please refer to FIG. 54 for the sixth embodiment of the present invention. The heat transfer surface 7 of outer part 1 of the first embodiment of the present invention may be designed to be a drum shape, where the LED printed circuit board may also be bent like a drum shape, thus the beam angle of the light bulb may be more omni.

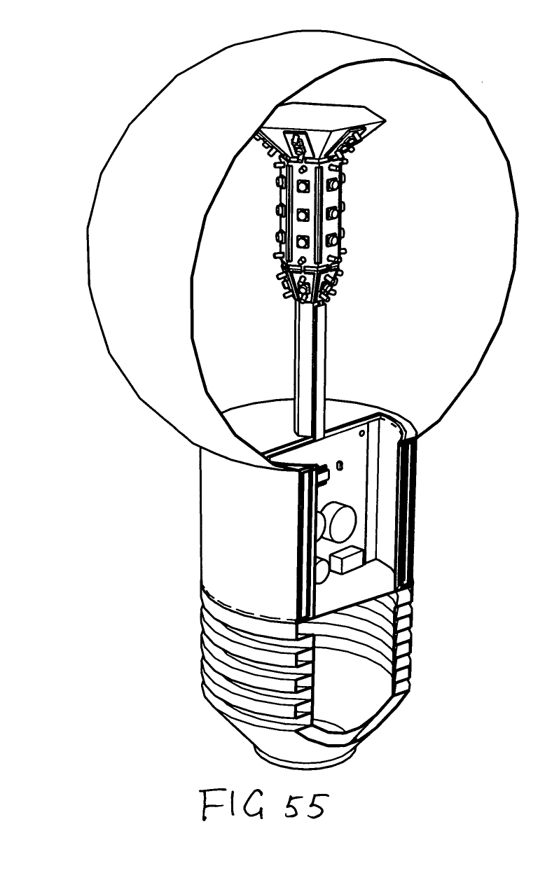

Please refer to FIG. 55 for the seventh embodiment of the present invention. The heat transfer surface 7 of the outer part 1 of the first embodiment of the present invention may be designed to be umbrella shape, where the LED printed circuit board may also be bent like umbrella shape, thus prevents the light going upward direction.

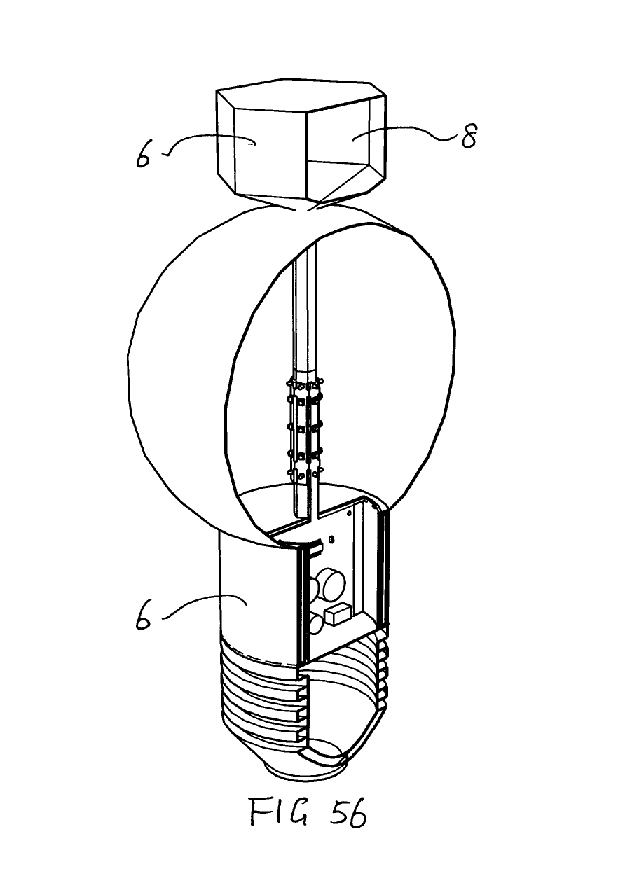

Please refer to FIG. 56 for the eighth embodiment of the present invention. The outer part 1 of the first embodiment of the present invention may be designed to have a second heat transfer surface 6, which two heat transfer surfaces 6 are located on both ends of said outer part 1. Said second heat transfer surface 6 of the outer part 1 will increase heat dissipation area, thus increase maximum allowable output power of the LED light bulb.

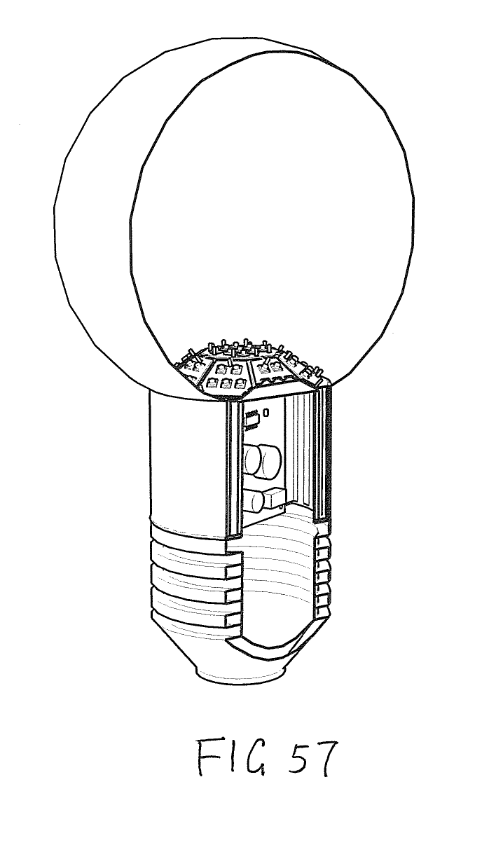

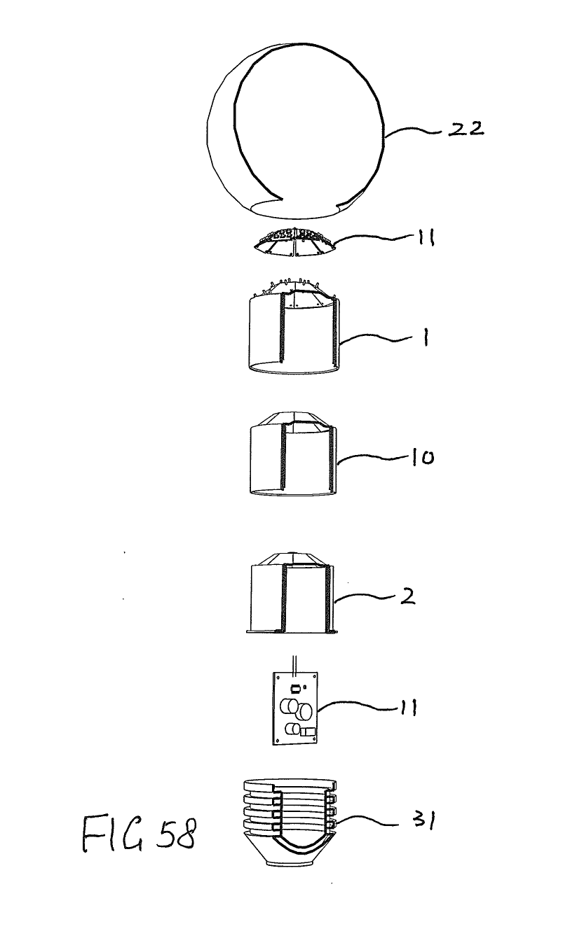

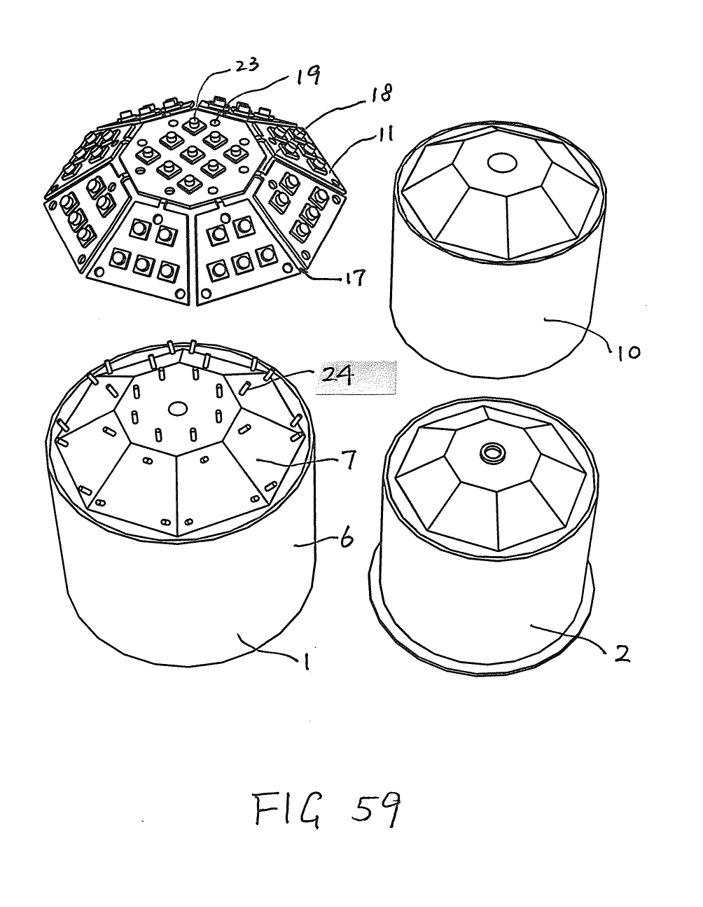

Please refer to FIGS. 57 to 59 for the ninth embodiment of the present invention. The heat transfer surface 7 of outer part 1 of the first embodiment of the present invention may be designed to be a flat surface with bulge in the center, which allows the LED printed circuit board to be bent and mounted on, thus the beam angle of the LED light bulb may be designed to be close to, equal to or larger than 180 degree as needed.

The manufacturing method of the LED light bulb apparatus of the present invention is described in details as below.

The outer part 1 and inner part 2 may choose from appropriate thermoplastic materials. The outer part 1 and inner part 2 may be pre-formed using conventional thermoplastic processing techniques, such as injection molding, extrusion, blowing or casting.

The outer part 1 and inner part 2 are aligned properly to form the vapor transport channel 8.

In one method the wick 10 is formed and inserted into the vapor transport channel 8. The wick 10 may be made of powder metal, mesh or fiber with conventional copper heat pipe processing techniques.

In another method the integrated grooves 13 on the vapor transport channel wall 12 are designed to be integrated into outer part 1 and inner part 2, achieved during fabricating the outer part 1 and inner part 2.

The working fluid 10 is introduced inside the vapor transport channel 8. Normally 30% of the internal space of vapor transport channel 8 is filled with working fluid 10. The volume of the working fluid 10 may be adjusted based on the shape and geometry of the vapor transport channel 8, with the essential requirement to keep working fluid 10 circulation during heat transfer operation. The working fluid 10 may be distilled water, but may also be other liquids like alcohol depends on the application and the thermoplastic material used for outer part 1 and inner part 2.

The vapor transport channel 8 then be evacuated conventionally. One example is by performing the body 20 assembly process inside an evacuated chamber.

The outer part 1 and inner part 2 are sealed closed conventionally. The methods include but not limited to gluing, hot plate welding, vibration welding and ultrasonic welding.

The LED printed circuit board 11 may be fabricated with conventional printed circuit board processing techniques.

The LED printed circuit board 11 may be assembled with components with conventional processing techniques, which include but not limited to surface mount techniques.

The LED printed circuit board 11 may be bent and hold in place on body 20. This process may be done manually, but a machine driven fixture is preferable which faster and more precisely.

The pins 24 may be heated and cooled down with an iron head 27, formed mushroom heads 25, this process may be done manually, but a machine driven fixture is preferable which faster and more precisely.

The base 31 is attached to body 20 and electrically connected to LED printed circuit board 11 with conventional processing techniques.

The cover 22 is optionally attached to body 20 with conventional processing techniques.

While embodiments of the present invention have been described in the foregoing specification and drawings, it is to be understood that the present invention is defined by the following claims when read in light of the specification and drawings.

We claim:

1. A LED light bulb apparatus comprising:
a body made of two thermoplastic parts, said body being sealed and having a wick inside said body that extends between two heat transfer locations spaced apart on an exterior surface of said body;
a vapor transport channel inside said body that extends between said two heat transfer locations;
and a working fluid that partially fills said vapor transport channel.

2. The LED light bulb apparatus of claim 1, in combination with a LED printed circuit board that is mounted on said body at one of said two heat transfer locations.

3. The LED light bulb apparatus of claim 2, said one of said two heat transfer locations of said body, which through plane thermal conductivity is higher than 0.5 W/mK.

4. The LED light bulb apparatus of claim 3, said one of said two heat transfer locations of said body, which has pins passing through said LED printed circuit board mounting holes.

5. The LED light bulb apparatus of claim 4, said pins being heated forming mushroom heads which hold said LED printed circuit board in place.

6. A LED light bulb apparatus comprising:
a body made of two thermoplastic parts, said body being sealed and having a plurality integrated groove channels inside said body that extends between two heat transfer locations spaced apart on an exterior surface of said body;
a vapor transport channel inside said body that extends between said two heat transfer locations;
and a working fluid that partially fills said vapor transport channel.

7. The LED light bulb apparatus of claim 6, in combination with a LED printed circuit board that is mounted on said body at one of said two heat transfer locations.

8. The LED light bulb apparatus of claim 7, said one of said two heat transfer locations of said body, which through plane thermal conductivity is higher than 0.5 W/mK.

9. The LED light bulb apparatus of claim 8, said one of said two heat transfer locations of said body, which has pins passing through said LED printed circuit board mounting holes.

10. The LED light bulb apparatus of claim 9, said pins being heated forming mushroom heads which hold said LED printed circuit board in place.

11. A method of making a LED light bulb apparatus comprising the steps of:
providing a body made of two thermoplastic parts;
providing a working fluid capillary action path and a vapor transport channel inside said body, said working fluid capillary action path and said vapor transport channel that extend between two heat transfer locations spaced apart on an exterior surface of said body;
providing a working fluid inside said body that partially fills said vapor transport channel;
sealing said body closed;
providing a LED printed circuit board that able to be bent;
mounting said LED printed circuit board on said body;
fixing said LED printed circuit board on said body with heat reshaped pins.
